(19) United States
(12) Patent Application Publication
(10) Pub. No.: US 2026/0304539 A1
(43) Pub. Date: Oct. 1, 2026

(54) METHODS, INFRASTRUCTURE EQUIPMENT, AND COMMUNICATIONS DEVICES

(71) Applicant: Sony Group Corporation, Tokyo (JP)

(72) Inventors: Shin Horng WONG, Basingstoke (GB); Basuki PRIYANTO, Lund (SE)

(73) Assignee: Sony Group Corporation, Tokyo (JP)

(21) Appl. No.: 19/477,792

(22) PCT Filed: Mar. 27, 2024
(86) PCT No.: PCT/EP2024/058338

§ 371 Date: Oct. 23, 2025

(30) Foreign Application Priority Data
Jun. 27, 2023 (EP) 23181917.8

(51) Int. Cl. H04W 76/25; H04B 17/318; H04L 1/00; H04W 72/1273

(52) U.S. Cl. CPC H04W 76/25; H04B 17/318; H04L 1/0003; H04W 72/1273

(57) ABSTRACT

A method of operating infrastructure equipment in a wireless communications network is provided. The method comprises receiving, from each of a plurality of communications devices, an indication of at least one radio channel characteristic associated with that device. The infrastructure equipment and the devices together form a subnetwork. Based on the received indications, the infrastructure equipment determines that one or more proximity groups are to be formed, each group including at least two devices having similar channel characteristics. The infrastructure equipment maintains the one or more proximity groups.

### BACKGROUND

### Field of Disclosure

The present disclosure relates to communications devices, infrastructure equipment and methods for the transmission and/or reception of data by a communications device in a wireless communications network.

The present application claims the Paris Convention priority from European patent application number EP 23181917.8, filed on 27 Jun. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different considerations may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

### SUMMARY OF THE DISCLOSURE

The present disclosure can help address or mitigate at least some of the issues discussed above.

Some embodiments of the present technique can provide a method of operating an infrastructure equipment forming part of a wireless communications network configured to transmit signals to and/or to receive signals from a communications device via a wireless access interface. The method comprises receiving, from each of a plurality of communications devices, an indication of at least one radio channel characteristic associated with that communications device, wherein the plurality of communications devices together with the infrastructure equipment form a subnetwork of the wireless communications network, determining, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications device in each proximity group, and maintaining, at the infrastructure equipment, the one or more proximity groups.

Such embodiments of the present technique, which, in addition to methods of operating infrastructure equipment, relate to methods of operating communications devices, to communications devices and infrastructure equipment, to circuitry for communications devices and infrastructure equipment, to wireless communications systems, to computer programs, and to computer-readable storage mediums, can allow for the more efficient and effective use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an NR-type wireless telecommunications system which may be configured to operate in accordance with certain embodiments of the present disclosure;

FIG. 2 is a schematic block diagram of an example infrastructure equipment and communications device which may be configured to operate in accordance with certain embodiments of the present disclosure;

FIGS. 3A, 3B, and 3C provide examples of subnetworks in which certain embodiments of the present disclosure may be implemented;

FIG. 4 illustrates an example of Physical Downlink Shared Channel (PDSCH) Hybrid Automatic Repeat Request (HARQ) transmission;

FIG. 5 illustrates an example of Physical Uplink Shared Channel (PUSCH) HARQ transmissions;

FIG. 6 shows an example of legacy PDSCH HARQ transmission for a particular scenario;

FIG. 7 shows an example of fast negative acknowledgement (NACK) HARQ feedback for the scenario shown in FIG. 6;

FIG. 8 shows an example of estimated HARQ feedback for the scenario shown in FIGS. 6 and 7;

FIG. 9 illustrates an example of HARQ transmission in Time Division Duplexing (TDD) systems;

FIG. 10 shows a part schematic, part message flow diagram representation of a wireless communications system comprising a communications device and an infrastructure equipment in accordance with embodiments of the present technique; and

FIG. 11 illustrates an example of proximity groups in a subnetwork in accordance with embodiments of the present technique;

FIG. 12 shows an example of pre-emptive retransmission using proximity grouping in accordance with embodiments of the present technique;

FIG. 13 shows an example of preventive scheduling using proximity grouping in accordance with embodiments of the present technique;

FIG. 14 shows an example of predictive retransmission based on previous transmissions by a UE using proximity grouping in accordance with embodiments of the present technique

FIG. 15 illustrates how proximity groups may be formed on the basis of channel profiles in accordance with embodiments of the present technique;

FIG. 16 illustrates an example of how a communications device may indicate a maximum Modulation and Coding Scheme (MCS) at which it would be able to successfully receive downlink signals from the network in accordance with embodiments of the present technique; and

FIG. 17 shows a flow diagram illustrating an example process of communications in a communications system in accordance with embodiments of the present technique.

### DETAILED DESCRIPTION OF THE EMBODIMENTS

### New Radio Access Technology (5G)

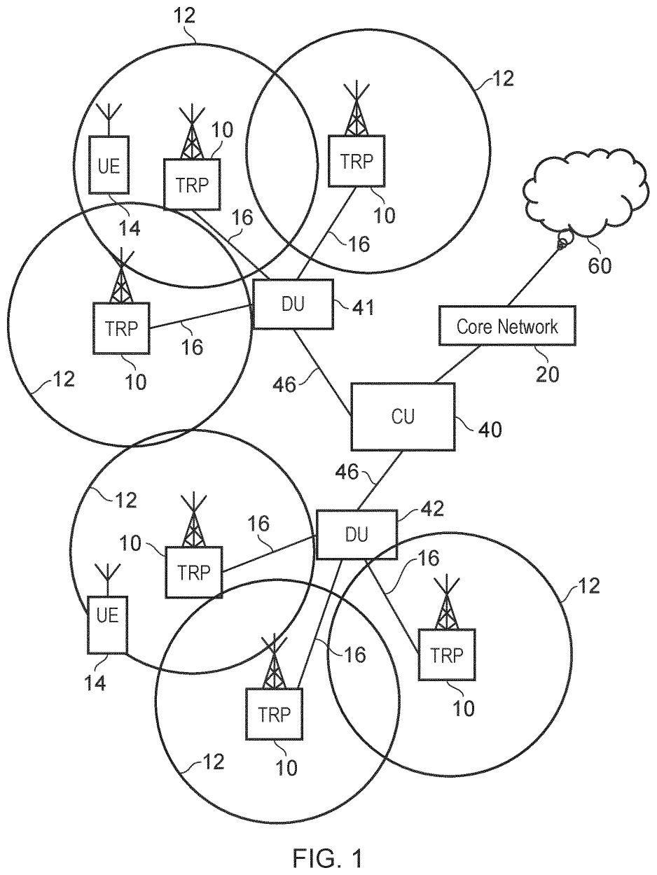

FIG. 1 provides a schematic diagram illustrating an example configuration of a wireless communications network which uses some of the terminology used in NR and 5G but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a coverage area (i.e. a cell) of the wireless communications network as represented by a circle 12, within which data can be communicated to and from communications devices 14. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30. The core network 20 routes data to and from communications devices 14 via the respective distributed units 41, 42 and provides functions such as authentication, mobility management, charging and so on. The core network 20 may further track the location of the communications devices 14 so that it can efficiently contact (i.e., page) the communications devices 14 for transmitting downlink data towards the communications devices 14.

The elements of the wireless access network shown in FIG. 1 may operate in a similar way to corresponding elements of an LTE network, or future generation mobile communications networks. It will be appreciated that operational aspects of the telecommunications network represented in FIG. 1, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The respective central units 40 and their associated distributed units/TRPs 10 of FIG. 1 may in part have base station functionality. Base stations, which are an example of network infrastructure equipment, may also be referred to as transceiver stations, nodeBs, eNodeBs, eNB, gNodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term (such as gNodeBs or the TRPs of FIG. 1) in relation to certain example implementations is not intended to indicate these implementations are limited to a certain generation of network that may be most associated with that particular terminology. The terms network infrastructure equipment/access node/access point may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. Although each TRP/DU is shown in FIG. 1 as a single entity, the skilled person will appreciate that some of the functions of the TRP/DU/base station may be carried out by disparate, inter-connected elements, such as antennas (or antennae), remote radio heads, amplifiers, etc. Collectively, one or more base stations may form a radio access network.

A communications device 14 is represented in FIG. 1 within the coverage area of the first communication cell 12. This communications device 14 may thus exchange signalling with the first central unit 40 in the first communication cell 12 via one of the distributed units/TRPs 10 associated with the first communication cell 12. Communications devices 14 may also be referred to as mobile stations, user equipment (UE), user terminal, mobile radio, terminal device, and so forth.

It will further be appreciated that FIG. 1 represents merely one example of a proposed architecture for a new RAT based telecommunications system in which approaches in accordance with the principles described herein may be adopted, and the functionality disclosed herein may also be applied in respect of wireless telecommunications systems having different architectures.

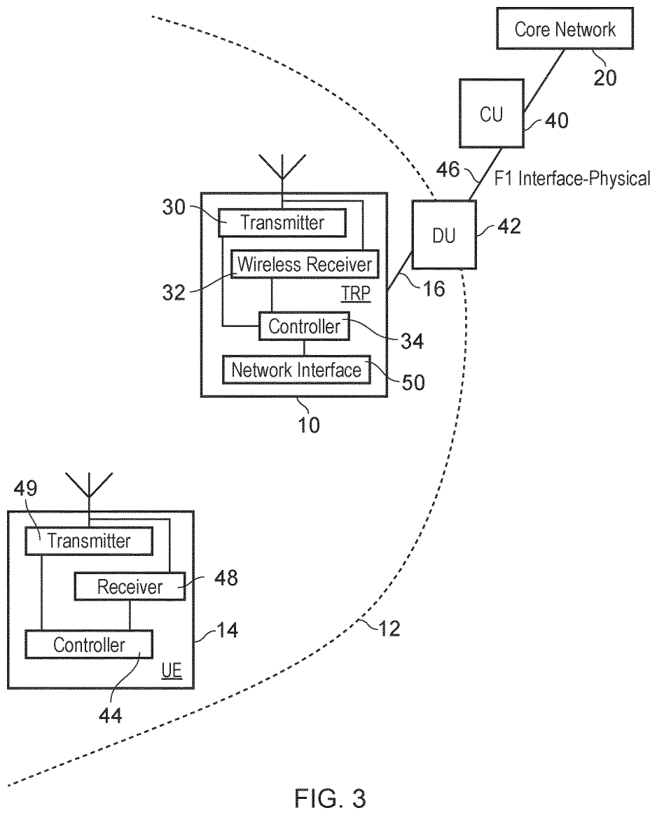

Thus, certain embodiments of the disclosure as discussed herein may be implemented in wireless telecommunication systems/networks according to various different architectures, such as the example architecture shown in FIG. 2. It will thus be appreciated the specific wireless telecommunications architecture in any given implementation is not of primary significance to the principles described herein.

In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a control unit/controlling node 40 and/or a TRP 10 of the kind shown in FIG. 1 which is adapted to provide functionality in accordance with the principles described herein.

A more detailed diagram of some of the components of the network shown in FIG. 1 is provided by FIG. 2. In FIG. 2, a TRP 10 as shown in FIG. 1 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 2, an example UE 14 is shown to include a corresponding transmitter 49, a receiver 48 and a controller 44 which is configured to control the transmitter 49 and the receiver 48 to transmit signals representing uplink (UL) data to the wireless communications network via the wireless access interface formed by the TRP 10 and to receive downlink (DL) data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 2 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 2, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### URLLC and eURLLC

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [1].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [2] specifies features that require high reliability and low latency, such as factory automation, transport industry, electrical power distribution, etc. in a 5G system. eURLLC is further enhanced as IIoT-URLLC [3], for which one of the objectives is to enhance UE feedback for Hybrid Automatic Repeat Request Acknowledgements (HARQ-ACK) for Physical Downlink Shared Channel (PDSCH) transmissions.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 1 and 2, where a significant number of additional features have been incorporated in different releases to provide new services and capabilities. Such services include eMBB, IloT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide. There are discussions on technologies beyond 5G, i.e., 6G, that are expected to have significantly higher throughput, lower latency and higher reliability than 5G services, which are also expected to utilize sub-THz frequencies. One of the functionalities being considered for 6G is operation within a subnetwork.

### Subnetworks

A subnetwork is a localized network of communication points. Subnetworks have the following characteristics:
Short range (below 10 meters) low transmit power cells;
Extreme requirements in terms of latency, reliability or data rates, i.e., below 0.1 ms latencies, reliability with a packet error rate of 1-10-9 (99.9999999%) reliability, and multi-Gbps data rates. A subnetwork can be defined as having any one or more of these latency, reliability, or data rate requirements;
Consist of one or multiple access points (AP), e.g., gNBs, with edge processing capabilities; and
May consist of a large number of low complexity or low cost communications devices, such as sensors or actuators.

The extreme reliability and latency of the subnetwork links, which can be downlink, uplink, or sidelink, make such subnetworks links suitable for replacing wires, thereby reducing the amount of wiring required in the system, which in some cases, e.g., in a car or robot, would result in a significant reduction of their weights and size. Reducing the amount of wiring required in a system or unit would also make manufacturing and installation of that system or unit easier.

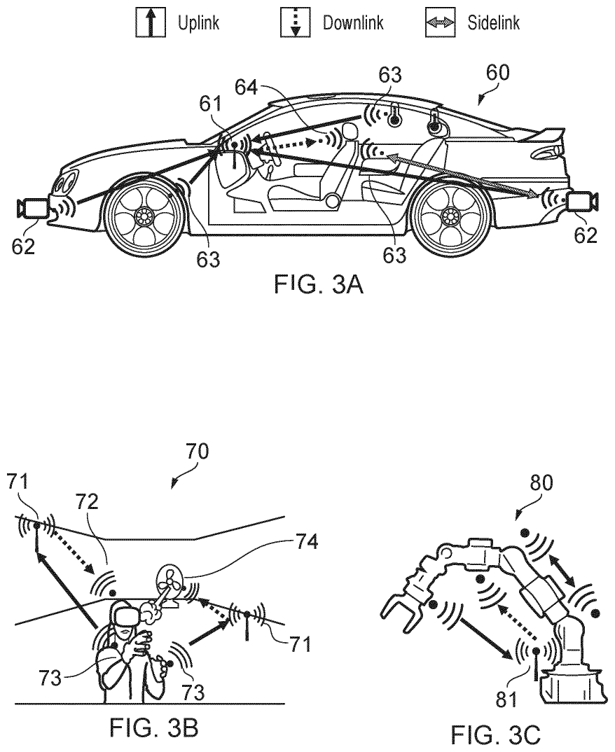

Some examples of subnetworks are shown in FIGS. 3A to 3C. Here, as shown in the example of FIG. 3A, a car 60 can consist of a subnetwork, where cameras 62, sensors 63 (such as light detection and ranging (LIDAR) or tyre pressure sensors), and entertainment devices 64 (such as screens or speakers) that are both outside and inside the car 60 together with an AP 61 can form a subnetwork. The wireless links of the subnetwork would significantly reduce the amount of required wiring, and hence weight, in the car 60.

In other use-cases, a subnetwork can also be in a living room for the purpose of providing immersive VR entertainment. An example of such a home entertainment based subnetwork 70 is shown in FIG. 3B, where a user's headset 72, movement sensors 73 in the user's haptic gloves, and a fan 74 that blows wind at intensity depending on the scenario currently being experienced in the immersive VR entertainment content may together all form a subnetwork which connects to multiple APs 71.

A subnetwork can also be within a single machine, such as a robot arm 80 as shown in the example of FIG. 3C. In the robot arm 80 shown in FIG. 3C, the sensors, joints, and pneumatic systems used to control movements, along with one or more APs 81, may together all form a subnetwork. Like in the car 60 as shown in the example of FIG. 3A, this may significantly reduce the amount of required wiring, which in turn would allow for the robot arm 80 to be made smaller and lighter.

### 5G HARQ Transmissions

In legacy systems such as 5G, a Hybrid Automatic Repeat Request (HARQ) transmission is used for the transmission of physical channels carrying data, such as Physical Downlink Shared Channels (PDSCHs) and Physical Uplink Shared Channels (PUSCHs). Here, such HARQ transmissions consist, after the initial transmission of the physical channels carrying the data, of HARQ feedback from the receiver and, if necessary, retransmissions from the transmitter. For example, an initial transmission of a physical channel may be transmitted to a receiver, and the receiver would feed back an ACK if it successfully decodes the physical channel, or otherwise it feeds back a NACK. A retransmission of the physical channel may be transmitted to the receiver if the HARQ feedback for the previous or initial transmission was a NACK, and here, the receiver would soft-combine the logarithmic likelihood ratio (LLR) soft bits of the retransmitted physical channel with all previous transmissions of the same physical channel. This would thereby increase the signal-to-noise ratio (SNR) of the transmission, and after the soft combining, the receiver then attempts to decode the transmission again. There is typically a configured maximum number of retransmissions of a physical channel before the transmission is abandoned.

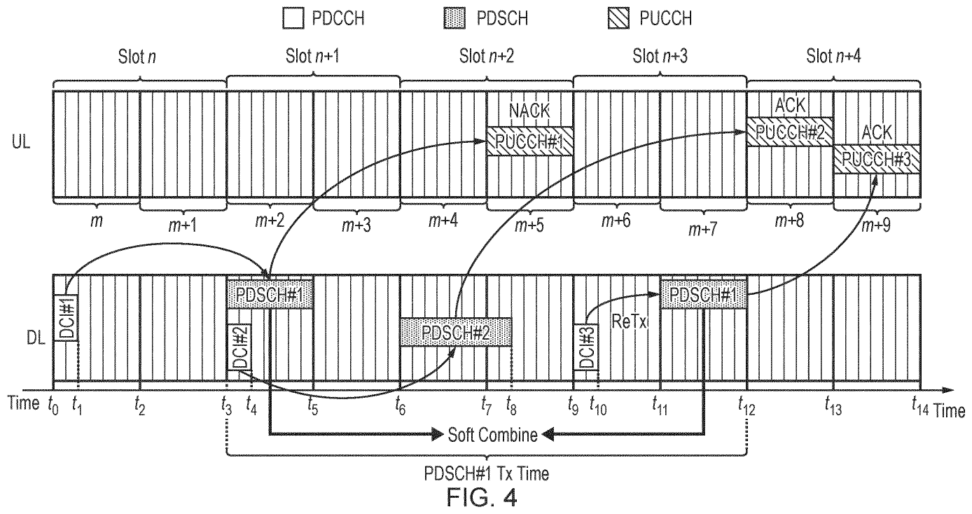

An example of PDSCH HARQ transmissions in the DL is shown in FIG. 4, where a DL Grant carried by downlink control information (DCI #1) is transmitted to a UE in Slot n to schedule a PDSCH #1 in Slot n+1 with a corresponding PUCCH #1 in sub-slot m+5 (Slot n+2) to carry the HARQ feedback for PDSCH #1. In the example of FIG. 4, the UE fails to decode PDSCH #1 and therefore feeds back a NACK in PUCCH #1. The gNB receiving the NACK would send another DL Grant DCI #3 in Slot n+3 scheduling a retransmission of a PDSCH #1 in the later part of Slot n+3 with a corresponding PUCCH #3 in sub-slot m+9 (Slot n+4). The UE soft-combines PDSCH #1 received in Slot n+1 with PDSCH #1 in Slot n+3, thereby increasing the SNR of the physical channel, and here, the UE successfully decodes PDSCH #1 and so feeds back an ACK using PUCCH #3. The total time required for the UE to successfully receive PDSCH #1 is the time between t₃ and t₁₂. The HARQ Round Trip Time (RTT) is the time between the transmission of the PDSCH and its following retransmission. For example, for PDSCH #1, the HARQ RTT is the time between time t3 and t11, which consists of processing time at both the UE and gNB. A Send and Wait (SAW) mechanism is employed for HARQ transmissions, where during the HARQ RTT of one HARQ process, another HARQ process can occur so that the resources can be fully utilised for data transmissions. In the example of FIG. 4, during the HARQ RTT for PDSCH #1, another HARQ process for PDSCH #2 can occur, where here, DL Grant DCI #2 in Slot n+1 schedules a PDSCH #2 in Slot n+2 with a corresponding PUCCH #2 in sub-slot m+8 (Slot n+4), where PDSCH #2 occurs between the initial PDSCH #1 in Slot n+1 and the PDSCH #1 retransmission in Slot n+3. The gNB and UE keep track of the HARQ process using a HARQ Process Number (HPN), and the UE maintains a soft buffer for each HARQ process for soft combining.

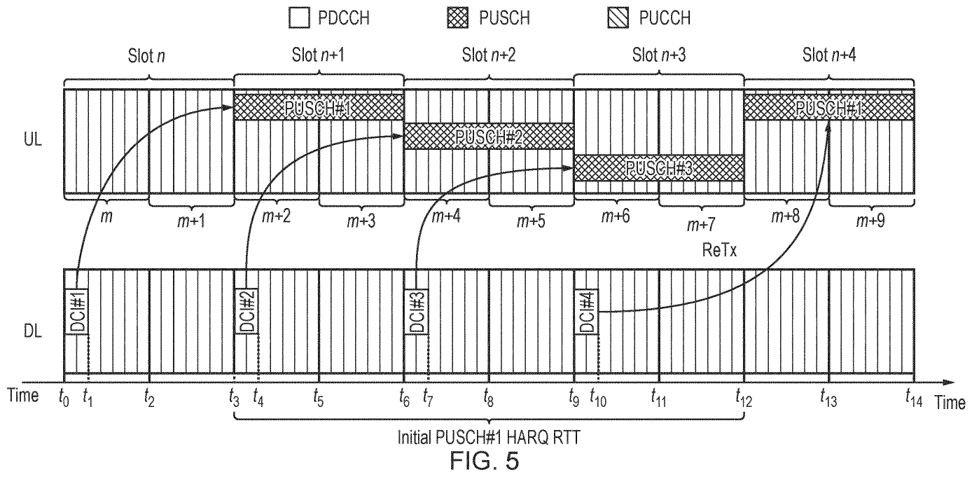

HARQ transmissions in the uplink for PUSCH is similar to those in the downlink for PDSCH as described above, and shown with respect to the example of FIG. 4. An example of PUSCH HARQ transmissions in the UL is illustrated by FIG. 5, which shows three HARQ processes for PUSCH #1, PUSCH #2, and PUSCH #3. The gNB transmits a UL Grant DCI #1 to the UE in Slot n to schedule an initial PUSCH #1 to be transmitted by the UE in Slot n+1. The gNB fails to decode PUSCH #1 and so transmits DCI #4 in Slot n+3 to schedule a retransmission for PUSCH #1 at Slot n+4, where after combining the initial PUSCH #1 transmission and its retransmissions, the gNB successfully decodes PUSCH #1. In 5G systems, unlike for PDSCH transmissions, the gNB does not provide an explicit HARQ feedback such as ACK or NACK for PUSCH. Instead, if the gNB needs a retransmission, it simply sends an UL Grant indicating that the PUSCH of a particular HPN is to be a retransmission (as opposed to a new initial transmission). The UE would store the PUSCH encoded bits in its HARQ buffer for a predetermined amount of time, where if then does not receive any UL Grant for a retransmission by the point this timer expires, the UE flushes its HARQ buffer (for that HPN) and assumes that the gNB has received the PUSCH successfully. In the example in FIG. 5, the gNB employs SAW, and transmits PUSCH #2 and PUSCH #3 back-to-back, to maximise the throughput of the UE during the HARQ RTT of the initial PUSCH #1.

The 6G subnetwork has a target of extremely high reliability and low latency as noted above, and so the legacy 5G HARQ transmission techniques may not meet such a high demand. Although the reliability may individually be reached by having a high number of retransmissions in 5G, each retransmission introduces latency due to the time required for decoding at the gNB or UE. For the PDSCH case, the HARQ feedback from the UE is issued before a retransmission can occur. Hence, there is motivation to improve the legacy HARQ transmission techniques currently employed in 5G for future use cases in 6G subnetworks.

### Fast NACK Feedback

In order to reduce the latency in HARQ retransmissions, fast NACK feedback was considered for PDSCH in co-pending European Patent Application, Publication No. EP4104343 [4], the contents of which are hereby incorporated by reference. Here, the UE is provided with two PUCCH resources, where a first PUCCH is used to carry a NACK and a second PUCCH is used to carry an ACK, and the first PUCCH is scheduled earlier than the second PUCCH in time. Hence, if the UE fails to decode a PDSCH, it would provide a NACK HARQ feedback faster than it would be able to transmit an ACK, to enable the gNB to quickly provide a retransmission of the PDSCH.

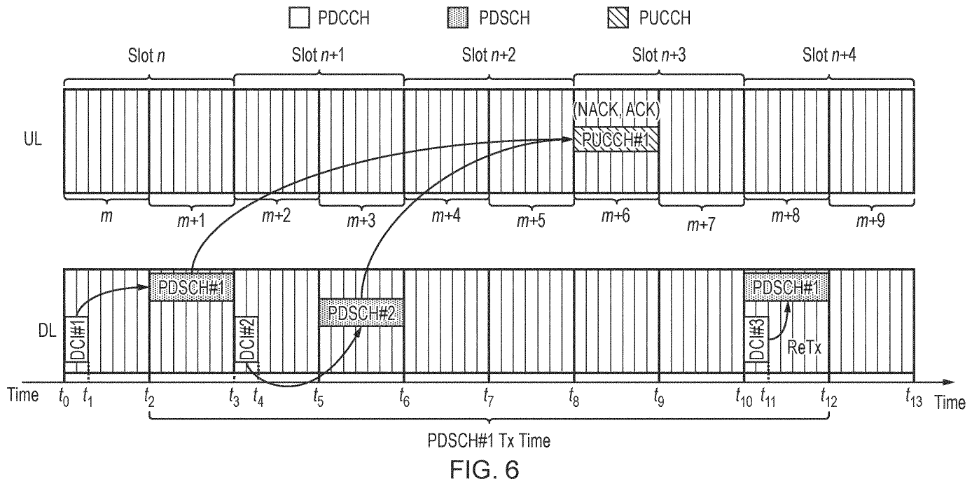

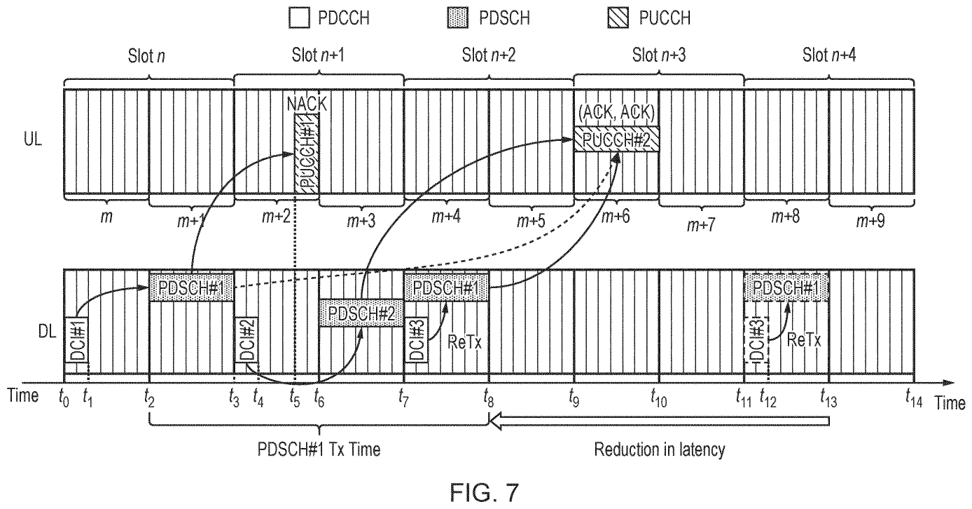

The examples of FIG. 6 and FIG. 7 respectively show how the legacy PDSCH HARQ transmission and fast NACK HARQ feedback may differ for the transmission of PDSCH #1. In the legacy PDSCH HARQ transmission shown in the example of FIG. 6, the gNB sends a DL Grant DCI #1 in Slot n to schedule PDSCH #1 in the same slot and with a corresponding PUCCH #1 to carry its HARQ feedback in Slot n+3. The gNB also sends DL Grant DCI #2 in Slot n+1 to schedule PDSCH #2 in the same slot with the HARQ feedback also in PUCCH #1. In 5G HARQ, feedbacks for multiple PDSCHs are typically multiplexed into a single PUCCH to reduce resources, and here, PUCCH #1 carries the HARQ feedbacks for PDSCH #1 and PDSCH #2. The UE fails to decode PDSCH #1 but successfully decodes PDSCH #2, and so it feeds back a NACK for PDSCH #1 and an ACK for PDSCH #2 in PUCCH #1 in Slot n+3. The gNB then sends another DL Grant DCI #3 in Slot n+4 to schedule a retransmission for PDSCH #1 in the same slot and, in this example, the UE successfully decodes PDSCH #1 after combining the retransmission with the initial transmission of PDSCH #1. The transmission time for PDSCH #1 is therefore t₁₂-t₂.

FIG. 7 shows the same scenario where the gNB transmits PDSCH #1 and PDSCH #2 to the UE, but here the system employs fast NACK feedback. Here, the UE is provided with two PUCCHs for PDSCH #1, i.e., PUCCH #1 for NACK if PDSCH #1 is not successfully received and decoded in sub-slot m+2 (Slot n+1) and PUCCH #2 in Slot n+3 as per legacy HARQ feedback techniques. PUCCH #2 also multiplexes HARQ feedback for PDSCH #2. When the UE fails to decode the initial PDSCH #1 in Slot n, the UE sends a NACK using PUCCH #1 in Slot n+1 and here the gNB is able to react quickly and send DL Grant DCI #3 in Slot n+2 to schedule a retransmission for PDSCH #1 in the same slot. In this example of FIG. 7, PUCCH #2 is used to carry the HARQ feedback for the retransmission of PDSCH #1. In this example, the UE successfully decodes PDSCH #1 after combining the initial transmission and retransmission of PDSCH #1. It can be appreciated that using fast NACK, the transmission time for PDSCH #1 is reduced from t₁₃-t₂ (corresponding to t₁₂-t₂ in the example of FIG. 6) to tₛ-t₂, thus providing a reduction in latency of t₁₃-t₈.

### Early Estimated HARQ Feedback

In [5], it is proposed to estimate the decoding outcome of a PDSCH based on LLR soft bits and provide an early HARQ feedback (effectively a prediction) in addition to the legacy HARQ feedback based on the outcome of full decoding. That is, the UE provides two HARQ feedbacks for a PDSCH decoding; an early HARQ feedback based on estimation of the decoding outcome from the LLR soft bits, and the legacy HARQ feedback based on the full decoding process of the PDSCH. The full decoding process of PDSCH takes a longer time than the estimation using LLR soft bits, and this therefore enables the estimated HARQ feedback to be sent to the gNB faster than the legacy HARQ feedback. Hence, where the estimated HARQ feedback proves on full decoding to be correct, the amount of latency in the system can be reduced.

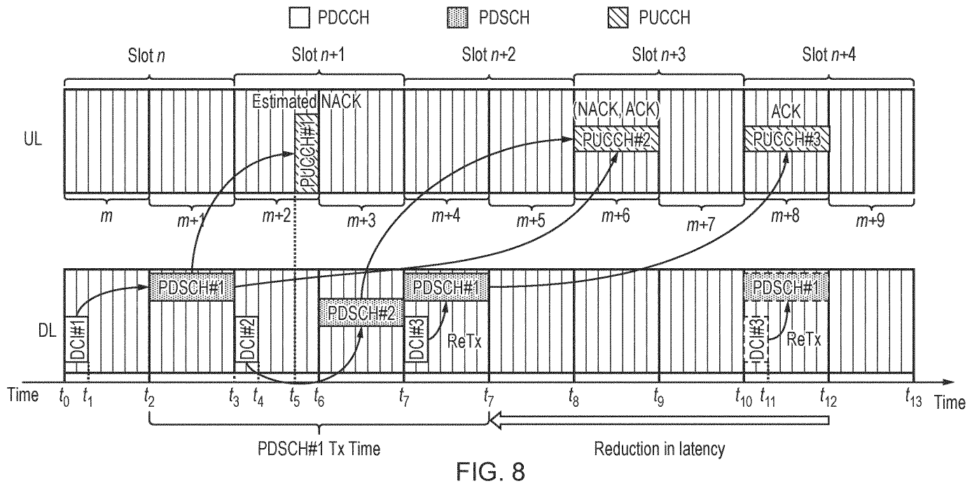

An example is shown in FIG. 8, which relates to the same scenario as those in FIGS. 6 and 7 but here, the example of FIG. 8 employs estimated HARQ feedback on the initial PDSCH #1 transmission in Slot n based on LLR soft bits. Based on the LLR soft bits of the initial PDSCH #1, the UE estimates that it would fail to decode PDSCH #1, and so sends a NACK in PUCCH #1 in Slot n+1, where PUCCH #1 is used to carry the estimated HARQ feedback. The gNB then sends DL Grant DCI #3 in Slot n+2 to schedule a retransmission of PDSCH #1 and with a corresponding PUCCH #3 in Slot n+4 to carry the HARQ feedback. In Slot n+3, the UE multiplexes HARQ feedbacks for PDSCH #1 and PDSCH #2 in PUCCH #2, where for PDSCH #1, it also provides the actual HARQ feedback based on the full decoding process and in this example the NACK for PDSCH #1 in PUCCH #2 confirms that the early NACK estimation is correct. In this example, the UE successfully decodes PDSCH #1 after combining the initial transmission and retransmission of PDSCH #1 and therefore feeds back an ACK in PUCCH #3. It can thus be observed from the example of FIG. 8 that using early estimation of HARQ feedback can reduce the transmission time of PDSCH #1, and thus reduce overall latency.

The fast NACK feedback methods in [4] and [5] both rely on the UE providing an early NACK or early estimated HARQ feedback so that the gNB is able to react quickly and issue a retransmission of the PDSCH where it is (or is expected to be) necessary. That is, the methods described in [4] and [5] and shown by way of the examples of FIGS. 6, 7, and 8 each assume that there are UL resource available for an early NACK, which is a reasonable assumption in an FDD system. However, in a TDD system, uplink resources are not always available at all times and therefore it may not be possible to provide an early estimated HARQ or NACK feedback.

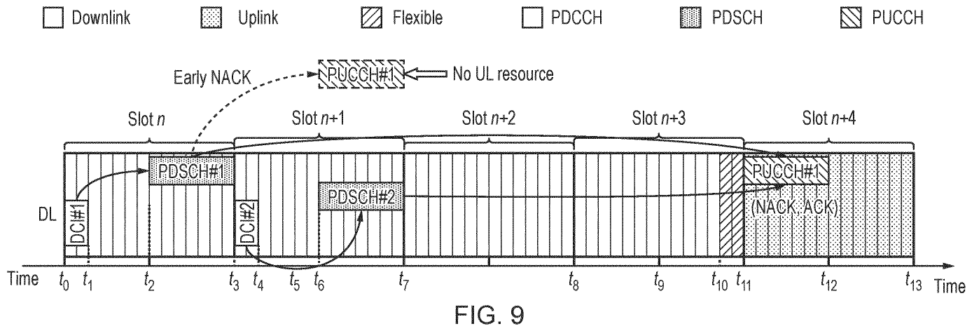

In a typical TDD network, the Slot Format may consist of a periodic pattern of 5 slots consisting of four DL slots followed by one UL slot, with one or two Flexible symbols prior to the UL slot for the purposes of timing advance and DL to UL transition time, as shown in the example of FIG. 9. The scenario in FIG. 9 is similar to the scenarios shown in FIGS. 6, 7, and 8, where the gNB transmits PDSCH #1 and PDSCH #2 to the UE, but in a TDD system. Since there are no UL resources from Slot n to Slot n+3, PUCCH #1 is scheduled in the earliest available UL slot in Slot n+4, where it carries the HARQ feedback for PDSCH #1 and PDSCH #2. The methods described in [4] and [5], and those described with regard to the examples of FIG. 7 and FIG. 8 respectively, cannot be implemented here, since any early HARQ feedback estimation or fast NACK decoding cannot be transmitted in Slot n+1. The earliest time the gNB can receive a NACK for PDSCH #1 is in the UL slot in Slot n+4, and so the gNB cannot perform early retransmission to reduce latency.

It should be noted that for higher frequencies such as FR 2 and sub-THz in 6G, the system is likely to be in TDD rather than FDD, and hence fast NACK methods may not be suitable. Therefore, a technical issue to solve here is to find a method that enables faster retransmissions in 6G systems, especially for 6G subnetworks that require extreme reliability and low latency. Embodiments of the present technique seek to provide solutions to such a technical issue.

### Proximity Group for Pre-Emptive Retransmissions and Preventive Scheduling

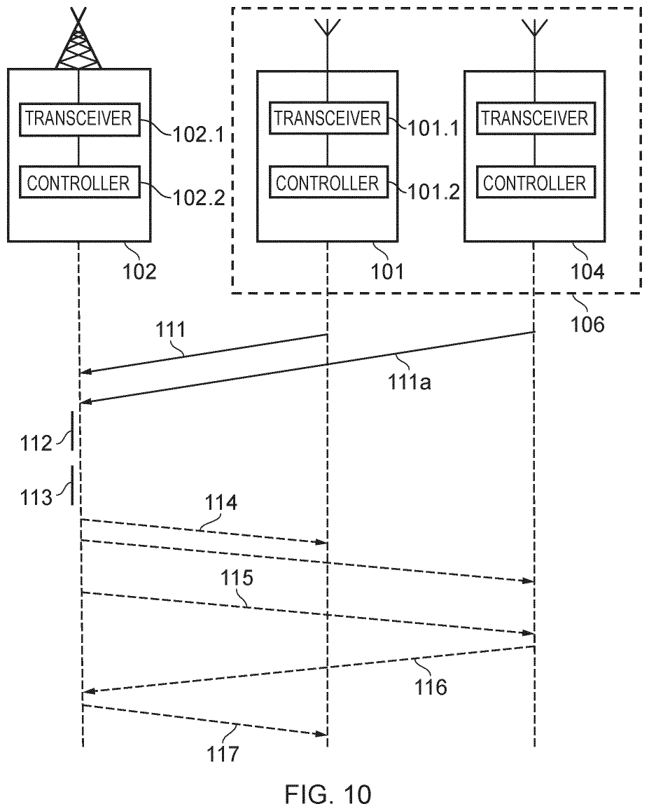

FIG. 10 shows a part schematic, part message flow diagram representation of a first wireless communications system comprising a communications device 101 (e.g. a UE 14) and an infrastructure equipment 102 (e.g. an AP such as a gNB/TRP 10) in accordance with at least some embodiments of the present technique. The communications device 101 is configured to transmit signals to and/or receive signals from the wireless communications network, for example, to and from the infrastructure equipment 102. Specifically, the communications device 101 may be configured to transmit data to and/or receive data from the wireless communications network (e.g. to/from the infrastructure equipment 102) via a wireless radio interface provided by the wireless communications network (e.g., a Uu interface between the communications device 101 and the Radio Access Network (RAN), which includes the infrastructure equipment 102). The communications device 101 and the infrastructure equipment 102 each comprise a transceiver (or transceiver circuitry) 101.1, 102.1, and a controller (or controller circuitry) 101.2, 102.2. Each of the controllers 101.2, 102.2 may be, for example, a microprocessor, a CPU, or a dedicated chipset, etc.

As shown in the example of FIG. 10, the transceiver circuitry 101.1 and the controller circuitry 101.2 of the communications device 101 are configured in combination to transmit 111, to the infrastructure equipment 102 of the wireless communications network, an indication of at least one radio channel characteristic associated with the communications device 101, wherein the communications device 101 forms a subnetwork of the wireless communications network together with the infrastructure equipment 102 and one or more other communications devices 104 (which may also be configured to transmit 111a, to the infrastructure equipment 102, an indication of at least one radio channel characteristic associated with that communications device 104), wherein the communications device 101 and at least a second of the other communications devices 104 each form part of a first proximity group 106 of the subnetwork, the first proximity group being associated with the infrastructure equipment 102. Although only two communications devices 102 and 104 are shown in the example of FIG. 10, those skilled in the art would appreciate that the first proximity group 106 (and indeed any other proximity group) could contain any feasible number of UEs.

In the example of FIG. 10, the infrastructure equipment 102 may be configured to determine 112, based on the received 111 indications of the at least one radio channel characteristic, that one or more proximity groups including the first proximity group 106 are to be formed, wherein each of the proximity groups is to comprise at least two of the plurality of communications devices of the subnetwork, the at least one radio channel characteristic being similar for all of the at least two communications device in each proximity group (such as for the communications device 102 and second communications device 104 in the first proximity group 106), and maintaining 113, at the infrastructure equipment 102, the one or more proximity groups. The infrastructure equipment 102 may then transmit 114, to one or more of the plurality of communications devices (such as the communications device 102 and/or second communications device 104, an indication of the proximity group (i.e. first proximity group 106) of which that communications device 102, 104 forms part.

The proximity groups may be used by the infrastructure equipment (i.e. AP) to perform predictive scheduling. In the example of FIG. 10 therefore, the communications device 101 may be configured to receive 117, from the infrastructure equipment 102, a downlink grant scheduling a set of downlink resources of the wireless access interface within which the infrastructure equipment 102 is to transmit first downlink data to the communications device 101 (which may be a second downlink grant scheduling a second set of downlink resources after the infrastructure equipment 102 had previously transmitted a first downlink grant scheduling a first set of downlink resources within which the infrastructure equipment 102 is to transmit the first downlink data to the communications device 101), wherein the set of downlink resources are scheduled based on a feedback signal transmitted 116 by the second communications device 104 to the infrastructure equipment 102 in response to second downlink data transmitted 115 by the infrastructure equipment 102 to the second communications device 104 indicating whether or not the second downlink data transmitted 115 by the infrastructure equipment 102 to the second communications device 104 was successfully received by the second communications device 104. Those skilled in the art would appreciate here that the infrastructure equipment 102 may transmit the (second) downlink grant scheduling the (second) set of downlink resources on the basis of feedback signals received from one or more other communications devices in addition to the feedback received 116 from the second communications device 104.

Essentially then, embodiments of the present technique propose that a proximity group is formed, which consists of UEs with similar radio channel characteristics relative to one or more APs (where here, such an AP may be a gNB, a relay node, an Integrated Access and Backhaul (IAB) node, or any other suitable apparatus). This enables the AP to estimate the decoding outcome of one UE based on a known decoding outcome of one or more other UEs within the proximity group, and allows that AP to take pre-emptive or preventive actions in scheduling that UE. Such embodiments of the present technique recognise that a subnetwork covers a small physical area, and therefore it is likely that there are UEs within that subnetwork that have very similar radio channel characteristics.

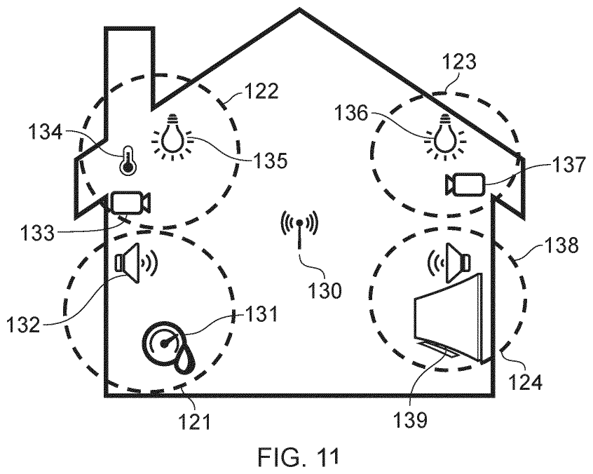

An example of how predictive scheduling may be used on the basis of proximity groups is shown in FIG. 11, where a subnetwork consists of one AP 130 and nine UEs 131-139 (or any such communications devices). Here, four proximity groups 121, 122, 123, 124 are formed, where the first proximity group 121 contains UE1 131 and UE2 132, the second proximity group 122 contains UE3 133, UE4 134, and UE5 135, the third proximity group 123 contains UE6 136 and UE7 137, and the fourth proximity group 124 contains UE8 138 and UE9 139. In the example of FIG. 11, the proximity groups 121, 122, 123, 124 are formed in such a way that UEs with similar physical positions are grouped together. However, it would be appreciated that this may not always be the case, and may only be the case in the example of FIG. 11 because the AP 130 is located in a relatively central physical position to each of the UEs 131-139. In other examples to that of FIG. 11, the proximity grouping may be carried out by the AP 130 on the basis of similar channel characteristics of UEs, or on a combination of such channel characteristics and the physical locations of those UEs.

As noted above, the proximity groupings enable an AP to take pre-emptive or preventive actions when making scheduling decisions. One such action is to schedule retransmissions in a pre-emptive manner. In other words, the feedback signal may indicate that the second communications device did not successfully receive the second downlink data, and the infrastructure equipment may be configured to determine, on the basis of the feedback signal, that the first communications device would not successfully receive the first downlink data within the first set of downlink resources, and to transmit, to the first communications device either before transmitting the first downlink data within the first set of downlink resources or after transmitting the first downlink data but before receiving the (HARQ) feedback from the first communications device on the decoding outcome of the first downlink data transmitted within the first set of downlink resources, the second downlink grant scheduling the second set of downlink resources of the wireless access interface within which the infrastructure equipment is to transmit a re-transmission of the first downlink data to the first communications device.

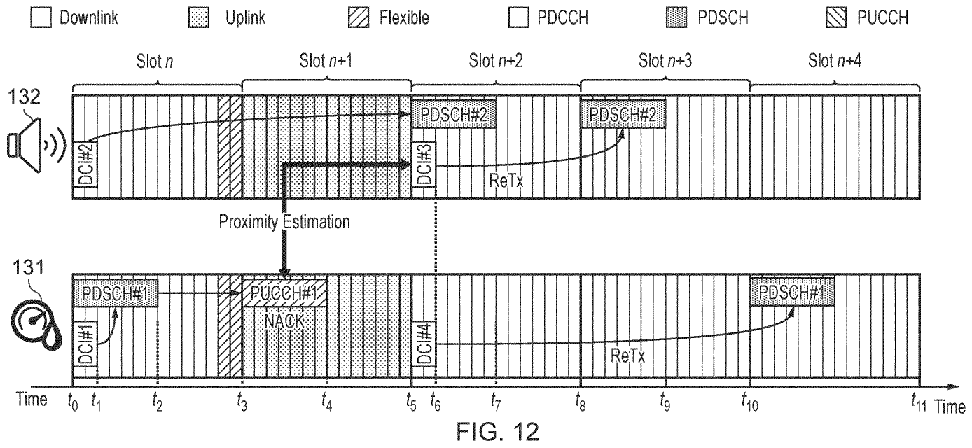

An example of such pre-emptive retransmission scheduling is illustrated in FIG. 12, where the HARQ transmissions for UE1 131 and UE2 132 of the first proximity group 121 in the example of FIG. 11 is shown in FIG. 12. Here, the AP 130 sends DL Grants DCI #1 and DCI #2 to UE1 131 and UE2 132 to schedule PDSCH #1 in Slot n and PDSCH #2 in Slot n+2 respectively. UE1 131 fails to decode PDSCH #1 and thus feeds back a NACK using PUCCH #1 in UL Slot n+1. Since UE1 131 and UE2 132 form a proximity group 121 with similar channel characteristics, the AP 130 estimates that UE2 132 is also likely to fail to decode PDSCH #2, and consequently, it sends DL Grant DCI #3 to schedule a pre-emptive retransmission of PDSCH #2 in Slot n+3 to UE2 132, without first waiting for any HARQ feedback from UE2 132. This therefore reduces latency in respect of successfully transmitting PDSCH #2 to UE2 132. The AP 130 also sends DL Grant DCI #4 in Slot n+2 to schedule a retransmission for PDSCH #1 to UE1 131 in response to the NACK received in Slot n+1.

It should be noted here that the AP 130 can use more than one UE's outcome in predicting the outcome of another UE. For example, with respect to the example of FIG. 11, feedback received from UE3 133 and UE4 134 in the second proximity group 122 in response to PDSCHs transmitted to those UEs may both be used to predict the outcome of a PDSCH transmitted to UE5 135 in that same second proximity group 122. It should also be noted that the UEs in a proximity group may change with time. For example, referring to the example of FIG. 3A, the movement of a robotic arm may result in changes to the makeup of UEs in different proximity groups, as the movement of the robotic arm will change those UEs' physical locations, as well as possibly change the radio channel characteristics they experience.

It should be appreciated that pre-emptive retransmission is not the only action that the AP or UE can take, and preventive scheduling, such as providing more robust scheduling where it is predicted to be needed, can be used. Retransmission is used for cases where the AP had already scheduled a PDSCH or PUSCH, such as in the example of FIG. 12. However, for cases where the AP has not yet scheduled anything, it can take preventive scheduling actions such as scheduling a PDSCH/PUSCH with repetitions, a higher transmit power, a lower MCS, and/or other resources (e.g., different resource blocks (RBs)) if another UE in the same proximity group is experiencing poor radio conditions. In other words, the feedback signal may indicate that the second communications device did not successfully receive the second downlink data, and the infrastructure equipment may be configured to determine, on the basis of the feedback signal, that the first communications device would not successfully receive the first downlink data transmitting within the first (i.e. initial) set of downlink resources, and to transmit, to the first communications device before transmitting the first downlink data within the first set of downlink resources, the second downlink grant scheduling the second set of downlink resources of the wireless access interface within which the infrastructure equipment is to transmit the first downlink data to the first communications device instead of in the first (i.e. initial) set of downlink resources, where here, the second set of downlink resources is configured with a different value of at least one parameter to the first set of downlink resources.

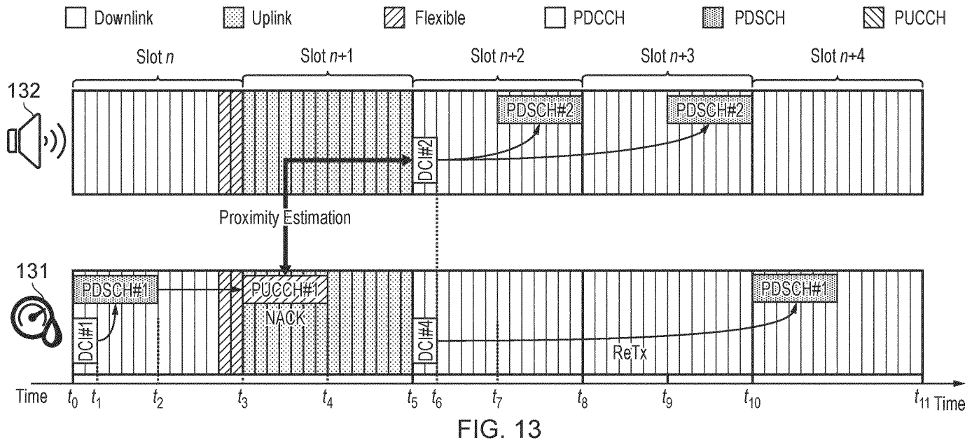

An example of such preventive scheduling is shown in FIG. 13, which again relates to UE1 131 and UE2 132, as shown in the example of FIG. 11, which belongs to the first proximity group 121. The AP 130 sends a DL Grant DCI #1 in Slot n to UE1 131 to schedule PDSCH #1 with a corresponding PUCCH #1 in UL Slot n+1. UE1 131 however fails to decode PDSCH #1 and so feeds back a NACK in PUCCH #1. Since UE1 131 and UE2 132 belong to the same proximity group 121, the AP 130 is then able to take a preventive scheduling decision, and accordingly sends DL Grant DCI #2 on a basis of this NACK to UE2 132 to schedule PDSCH #2 with two repetitions to reduce the chance of UE2 132 failing to decode PDSCH #2.

As those skilled in the art would appreciate, predictive scheduling-such as pre-emptive retransmission or preventive scheduling using proximity groups-is also applicable in the uplink. Here, a UE in a particular proximity group may receive an UL Grant scheduling a PUSCH retransmission, or may receive some negative feedback associated with the radio conditions from the AP. Here, this UE can indicate using sidelink signalling to one or more other UEs in its proximity group, so that those other UEs can take pre-emption actions. For example, one of these UEs can send a retransmission of a PUSCH before the AP asks for such a retransmission. In other words, the infrastructure equipment may be configured to transmit, to a first of the communications devices, either a feedback signal indicating that first uplink data transmitted by the first communications device to the infrastructure equipment was not successfully received by the infrastructure equipment or uplink grant scheduling a set of uplink resources of the wireless access interface within which the first communications device is to transmit a re-transmission of first uplink data to the infrastructure equipment, the first uplink data having previously been received by the infrastructure equipment from the first communications device. Here, this first communications device may transmit-to another communications device-either an indication that the infrastructure equipment did not successfully receive the first uplink data or an indication that the infrastructure equipment has transmitted the uplink grant to the first communications device. The infrastructure equipment may then be configured to receive, from a second of the communications devices, a re-transmission of second uplink data, the second uplink data having previously been received by the infrastructure equipment from the second communications device, wherein the re-transmission of the second uplink data is received without the infrastructure equipment having indicated that the second communications device was to transmit the re-transmission of the second uplink data.

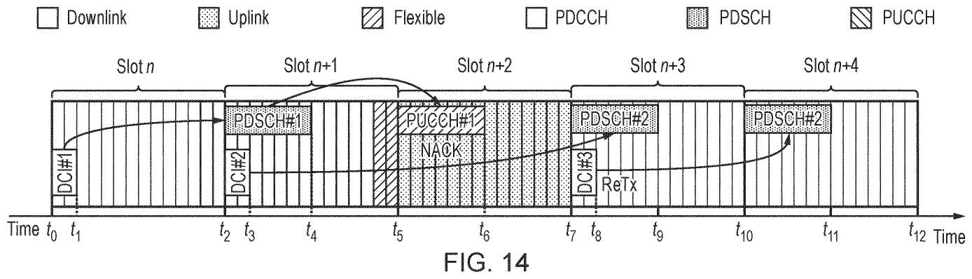

As those skilled in the art would appreciate, predictive scheduling can also be done with one UE for transmissions that are close in time or within the coherent time of the channel. Here, the AP predicts the outcome of a scheduled transmission that has not yet been decoded based on a previously decoded transmission whose outcome is known. An example is shown in FIG. 14, where the AP sends DL Grant DCI #1 to a UE in Slot n to schedule PDSCH #1 in Slot n+1 with corresponding PUCCH #1 in Slot n+2. The AP then sends DL Grant DCI #2 to the same UE to schedule PDSCH #2 in Slot n+3. The AP receives a NACK in PUCCH #1 indicating that the UE has failed to decode PDSCH #1, and here, the AP determines that PDSCH #1 and PDSCH #2 are close in time, i.e., within the channel coherent time, and so predicts that the UE will also likely fail to decode PDSCH #2. Based on this prediction, the AP sends DL Grant DCI #3 to pre-emptively schedule a retransmission for PDSCH #2. Here, the AP may pre-emptively schedule the retransmission for PDSCH #2 based on the decoding outcome of one or more other UEs (in the same proximity group as the UE to which the retransmission for PDSCH #2 is scheduled) instead of (or in addition to) the NACK received in PUCCH #2 indicating that the UE has failed to decode PDSCH #1.

As shown in the example of FIG. 14, the UE receives two PDSCH #2 based on DCI #2 and DCI #3. Here, essentially, the UE receives two PDSCH #2 to improve the reliability of reception of the data carried by PDSCH #2. However, it is of course possible—despite the possibility of unsuccessful reception/decoding that caused the second PDSCH #s to be scheduled by DCI #3—the UE could still successfully decode PDSCH #2 when it receives it the first time. Here, the UE may not be mandated to decode the second PDSCH #2. In other words, the communications device may be configured to receive, from the infrastructure equipment, a first downlink grant scheduling a first set of downlink resources of the wireless access interface within which the infrastructure equipment is to transmit an initial transmission of first downlink data to the communications device, to receive, from the infrastructure equipment, a second downlink grant scheduling a second set of downlink resources of the wireless access interface within which the infrastructure equipment is to transmit a re-transmission of the first downlink data to the communications device, to receive the initial transmission of the first downlink data in the first set of downlink resources from the infrastructure equipment, to determine that the initial transmission of the first downlink data was successfully receive by the communications device, and subsequently, to determine that the communications device is not to receive the re-transmission of the first downlink data in the second set of downlink resources from the infrastructure equipment.

On the other hand, in the case the does UE fail to decode the first PDSCH #2, the UE would then be expected to perform combining of the two PDSCH #2 (e.g., soft-combining) so that the reliability can be improved. In other words, the communications device may be configured to receive, from the infrastructure equipment, a first downlink grant scheduling a first set of downlink resources of the wireless access interface within which the infrastructure equipment is to transmit an initial transmission of first downlink data to the communications device, to receive, from the infrastructure equipment, a second downlink grant scheduling a second set of downlink resources of the wireless access interface within which the infrastructure equipment is to transmit a re-transmission of the first downlink data to the communications device, to receive the initial transmission of the first downlink data in the first set of downlink resources from the infrastructure equipment, to determine that the initial transmission of the first downlink data was not successfully receive by the communications device, and subsequently, to determine that the communications device is to receive the re-transmission of the first downlink data in the second set of downlink resources from the infrastructure equipment and to combine the received re-transmission of the first downlink data with the initial transmission of the first downlink data.

Such behaviour at the UE (i.e. not decoding the second PDSCH #2 when predictively scheduled in advance) may relate to the example of FIG. 14, with a single UE and the predictive scheduling being performed based on feedback from that single UE, or to an example such as that shown in FIG. 13, with multiple UEs and the predictive scheduling being performed for one UE based on feedback from another UE in the same proximity group.

The radio channel characteristics used for grouping of UEs in proximity group may be any appropriate radio channel characteristics. In some arrangements of embodiments of the present technique, the said radio channel characteristic used to select UEs in a proximity group is the channel estimation of the UEs. In other words, the at least one radio channel characteristic indicated by each communications device may be an estimation of a channel profile performed by that communications device. That is, UEs with similar channel profiles are grouped into a proximity group. The channel profile can consist of the channel taps and delay spread, as would be well understood by those skilled in the art.

In some arrangements of embodiments of the present technique, the channel profile is quantized using thresholds of the strength of each channel taps and position in time. In other words, the channel profile may be a quantized channel profile, the quantized channel profile having been quantized by indicating a received signal strength at each of a plurality of time points relative to one or more threshold received signal strengths.

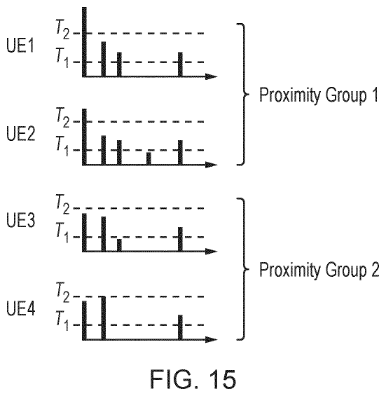

An example implementation of such arrangements is in FIG. 15, where the position of each tap (in time along the delay spread) and its strength are used to determine if two UEs have the same radio channel characteristics. For the strength aspect, two thresholds T₁ and T₂ are used in the example of FIG. 15, where any taps with strength above T₁ are considered as valid. Strengths between T₁ and T₂ are considered mid strength and any taps with strengths above T₂ are considered high strength. UEs' channel profiles that have the same pattern of mid and high strengths may be grouped into a proximity group. For example, in FIG. 15, UE1 and UE2 have the same pattern of mid and high strengths (because the fourth tap of UE2 does not reach threshold T₁ and so is not considered as valid) and so they are grouped into proximity group 1. Similarly, UE3 and UE4 have the same pattern of mid and high strengths (because the third tap of UE3 does not reach threshold T₁ and so is not considered as valid) and so they are grouped into proximity group 2. It should be appreciated that any other number and/or position of thresholds can be used, and such arrangements are thus not restricted to only two thresholds.

In some arrangements of embodiments of the present technique, the said radio channel characteristics is the physical position of the UE. In other words, the at least one radio channel characteristic indicated by each communications device may be a physical position of that communications device. That is, UEs within a specified radius or area may be grouped into a proximity group. This recognises that the radio channel of a UE is highly correlated with its physical position, due to the presence of particular obstacles relative to the AP to which those UEs are corrected being roughly the same among those UEs, as well as the relative position of the AP itself. As such, UEs within the same physical area are likely to have the same radio channel characteristics.

In some arrangements of embodiments of the present technique, the said radio channel characteristics are indicated implicitly by (and thus determined by the AP from) reference signals, such as SRS and DMRS, transmitted from the UE. In other words, the infrastructure equipment may be configured to receive, from each of the plurality of communications devices, one or more reference signals, wherein the one or more reference signals comprise the received indication of the at least one radio channel characteristic, and to determine the at least one radio channel characteristic from the received one or more reference signals.

This is beneficial for proximity group for UL transmission as the UL radio propagation channel may be different to the DL radio propagation channel, e.g., in FDD deployment. For TDD deployment, the AP may assume channel reciprocity and estimate the DL radio channel characteristics using the UL radio channel characteristics determined from the UE Reference Signals.

In some arrangements of embodiments of the present technique, a UE may belong to more than one proximity group. Such arrangements recognise that a subnetwork may have more than one AP, and the UE may have one proximity group per AP since the radio channel characteristics between the UE and one AP may be different to those between the UE and another AP. In other words, at least one of the plurality of communications devices of the subnetwork may form part of at least two of the proximity groups, where here, one of the at least two proximity groups of which the at least one of the plurality of communications devices of the subnetwork forms part may be associated with the infrastructure equipment, and the others of the at least two proximity groups of which the at least one of the plurality of communications devices of the subnetwork forms part may be associated with one or more other infrastructure equipment of the subnetwork.

In some other arrangements of embodiments of the present technique however, the UE may belong to more than one proximity group even for the same AP. In other words, at least one of the plurality of communications devices of the subnetwork may form part of at least two of the proximity groups, where here, all of the at least two proximity groups of which the at least one of the plurality of communications devices of the subnetwork forms part may be associated with the infrastructure equipment. This may be beneficial for cases where the UEs in a subnetwork have movements which are known or predictable relative to the AP; for example, if those UEs are attached to or form part of a robotic arm. Hence, as the UEs move, their radio channel characteristics relative to the same AP change, and so their proximity groups may be configured to change accordingly. In this case, it may be beneficial to configure the UE with more than one proximity group and so to switch between proximity groups when the UE moves to a known point. Alternatively, the AP can use physical channel signalling such as DCI signalling to quickly switch a UE from one proximity group to another. For deployments where channel reciprocity cannot be assumed, such as in FDD, the UE may belong to more than one proximity groups for the same AP, so that it can have different proximity groups for UL transmissions and DL transmissions.

In some arrangements of embodiments of the present technique, a UE may belong to more than one proximity group. However, there is only one active proximity group at any particular point in time. In other words, at least one of the plurality of communications devices of the subnetwork may form part of at least two of the proximity groups, where here one of the at least two proximity groups of which the at least one of the plurality of communications devices of the subnetwork forms part may be active at any given time.

Some arrangement of embodiments of the present technique define methods and types of signalling, exchanged between the AP and UEs, and indeed among UEs, that are considered beneficial to the implementation of predictive scheduling/retransmission based on proximity grouping. In some such arrangement of embodiments of the present technique, the UE reports its DL channel profile to the AP. The channel profile can be the received signal strength (e.g. RSRP) and time of each tap on the delay line profile. In an implementation, the channel profile can be a quantized channel profile as described above in relation to the example illustrated by FIG. 15. In other such arrangement of embodiments of the present technique, the UE reports its position or the area it is in within the subnetwork to the AP. The reported position information can be in a form of relative distance to the AP within a subnetwork.

In some arrangement of embodiments of the present technique, the UE reports the maximum modulation and coding scheme (MCS) and/or channel quality indicator (CQI) that it can tolerate at a predefined block error rate (BLER). That is, the UE reports the maximum MCS/CQI it can successfully decode a PSDCH based on the current radio condition, where at any MCS higher than the reported maximum MCS, the UE would fail the decoding. In other words, the communications device may be configured to receive, from the infrastructure equipment, first downlink data, and to transmit, to the infrastructure equipment, an indication of a maximum modulation and coding scheme, MCS, that, if the first downlink data had been transmitted in accordance with the maximum MCS, the communications device would have been able to successfully receive the first downlink data in accordance with a predefined error rate. This indication of the maximum MCS may be transmitted along with feedback for the first downlink data (where that feedback is constituted by an ACK or by a NACK) or may be transmitted independently of any such feedback or indeed anything else. Hence, in addition to a CQI which indicates the MCS the UE can achieve for a hypothetical PDSCH at a targeted BLER, the UE also reports another (theoretical maximum) MCS/CQI that it can barely achieve; e.g. a MCS/CQI at a higher BLER. This indication is useful to the AP, especially for cases when a first UE in the proximity group feeds back an ACK, since the ACK only tells the AP that the UE successfully decoded a PSDCH of a particular MCS but it doesn't provide information for the AP whether another transmitted PDSCH which was configured in accordance with a different MCS to another UE of the same proximity group would be successfully decoded by that other UE or not.

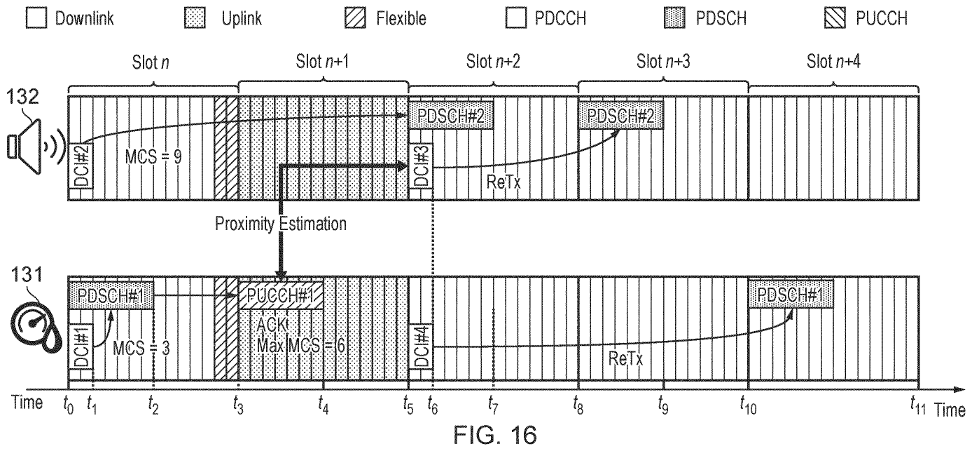

An example is shown in FIG. 16, where UE1 131 is scheduled a PDSCH #1 with MCS=3 in Slot n. Here, UE1 successfully decodes PDSCH #1, and so feeds back an ACK. In addition to the ACK, the UE also feeds back a maximum MCS=6 in PUCCH #1 in Slot n+1. In Slot n, the AP 130 has also scheduled UE2 132 with PDSCH #2 with MCS=9 in Slot n+2. Upon receiving the max MCS=6, the AP 130 realizes that UE2 132 is likely to fail to decode PDSCH #2 since UE1 131 and UE2 132 are in the same proximity group and hence are likely experiencing the same or similar channel conditions. Consequently, the AP sends DL Grant DCI #3 in Slot n+2 to schedule a retransmission for PDSCH #2 in Slot n+3. As noted above, it should be appreciated that the maximum MCS/CQI indication can also be sent independently of HARQ feedback.

In some arrangement of embodiments of the present technique, the AP can issue a measurement command to the UE to perform at least some of the measurements described in the paragraphs above. In other words, the infrastructure equipment may be configured to transmit, to each of the plurality of communications devices of the subnetwork, a measurement command, where here, the infrastructure equipment receives the indication of the at least one radio channel characteristic associated with each communications device based on the transmitted measurement command. Such a measurement command can indicate that such measurements should be performed (and/or reported) periodically, semi-persistently, aperiodically, or based on some kind of event trigger. The AP can then use the reported DL channel profile/other radio channel characteristic from multiple UEs within a subnetwork to form proximity groups.

In some arrangement of embodiments of the present technique, the AP can configure the measurements for the UEs semi-statically in radio resource control (RRC) signalling or dynamically using Group Common DCI (GC-DCI) or dedicated DCI on a per-UE basis. In other words, the infrastructure equipment may be configured to transmit, to each of the plurality of communications devices of the subnetwork, an indication of a configuration in accordance with which that communications device is to transmit measurements to the infrastructure equipment, where here, the infrastructure equipment receives the indication of the at least one radio channel characteristic associated with each communications device based on the indicated configuration In an implementation, UEs belonging to a proximity group may share the same GC-DCI.

In some arrangement of embodiments of the present technique, the UE reports the measurements together with its HARQ feedbacks. In other words, the communications device may transmit the indication of the at least one radio channel characteristic associated with the communications device together with a feedback signal indicating whether or not the communications device successfully received at least one downlink signal transmitted to it by the infrastructure equipment.

In some arrangement of embodiments of the present technique, the said event trigger is the change in UE position. That is if the UE moves out of a predefined area, it will report its DL channel profile to the AP. In other words, the measurement command may indicate that each communications device is to transmit the indication of the at least one radio channel characteristic associated with that communications device if that communications device moves out of a predetermined geographical area.

In some arrangement of embodiments of the present technique, the said event trigger is a change in the channel profile pattern. For example, if one or more taps in the channel profile pattern change position in time, or change its strength, (e.g. moves from one threshold to another as exemplified by FIG. 15), then the UE reports an updated channel profile to the AP. In other words, the measurement command may indicate that each communications device is to transmit the indication of the at least one radio channel characteristic associated with that communications device if an estimation of a channel profile performed by that communications device changes from a previous estimation of the channel profile.

It should be appreciated that the above-described measurement reports can implemented individually or combined together. That is, the AP can configure a UE to report multiple measurements.

In some arrangement of embodiments of the present technique, the AP signals to the UE the proximity group it belongs to. In other words, the infrastructure equipment may be configured to transmit, to one or more of the plurality of communications devices, an indication of the proximity group of which that communications device forms part. Here, the AP decides the grouping, that can be based on the UE reports. The proximity group signalling can be carried out via higher layer signalling (e.g., RRC messages). There can be initial/predefined UEs within a group, especially if the UEs are statically placed. The AP can change (through removing or adding UEs) the grouping of a UE from one proximity group to another, to adapt to changes in the UE radio channel characteristic. In other words, the infrastructure equipment may determine that at least one of the communications devices should be removed from a proximity group of which it currently forms part, and/or that at least one of the communications devices should be added to an existing proximity group of which it currently does not form part. This signalling may or may not be actually transmitted to those UEs concerned.

In some arrangement of embodiments of the present technique, the AP may signal to a particular UE the UE IDs or UEs that belong to the same proximity group as that UE. In other words, the infrastructure equipment may be configured to transmit, to one or more of the plurality of communications devices, an indication of identifiers associated with one or more others of the plurality of communications devices with which that communications device forms part of the same proximity group. This enables UEs in the same proximity group to transmit signalling to each other via the sidelink interface, which may include, for example, indications of the decoding outcome of a PDSCH or PUSCH for the purposes of predictive scheduling in the uplink on the UE side.

In some arrangements of embodiments of the present technique, the AP signals an indication that would enable UEs in a proximity group to perform preventive scheduling/retransmission. In other words, the infrastructure equipment may be configured to transmit, to at least a first of a plurality of communications devices in a first proximity group, information to be used by the first communications device in transmitting uplink data to the infrastructure equipment.

In some such arrangements of embodiments of the present technique, the AP signals to the UEs in a proximity group, the decoding outcome of one or more uplink channel from one or more UEs in that proximity group. This then enables the UEs in the proximity group to determine whether to take preventive measures in their upcoming UL transmissions. For example, the AP may broadcast, e.g. using GC-DCI, that it has failed to receive a PUSCH from a UE in the proximity group, and this may then allow another UE, realizing this, to decide to transmit its upcoming PUSCH with at least one changed parameter, e.g. at a higher transmit power, or to transmit a re-transmission without first being prompted by the AP. In other words, the information may comprise an indication that the infrastructure equipment did not successfully receive first uplink data transmitted by at least a second of the plurality of communications devices in the first proximity group, and wherein the infrastructure equipment may be configured to receive, from the first communications device, a re-transmission of second uplink data, the second uplink data having previously been received by the infrastructure equipment from the first communications device, wherein the re-transmission of the second uplink data is received without the infrastructure equipment having indicated that the first communications device was to transmit the re-transmission of the second uplink data.

In some arrangement of embodiments of the present technique, the AP signals the maximum MCS it can tolerate for a PUSCH to UEs in a proximity group. In other words, the information may comprise an indication of a maximum modulation and coding scheme, MCS, that, if uplink data were to be transmitted to the infrastructure equipment from that communications device in accordance with the maximum MCS, the infrastructure equipment would have been able to successfully receive the uplink data in accordance with a predefined error rate. Here, the indication of the maximum MCS may indicate that, if the uplink data had been transmitted in accordance with an MCS higher than the maximum MCS, the infrastructure equipment would not have been able to successfully receive the uplink data in accordance with the predefined error rate. This is beneficial for UL transmissions such as PUSCH. For example, the UE may have an upcoming configured grant PUSCH (CG-PUSCH) transmission, or may have already been scheduled a PUSCH transmission with an MCS that exceeds the indicated max MCS. Therefore, the UE can take preventive actions, such as transmitting the CG-PUSCH or PUSCH at a higher power or by transmitting a pre-emptive retransmission.

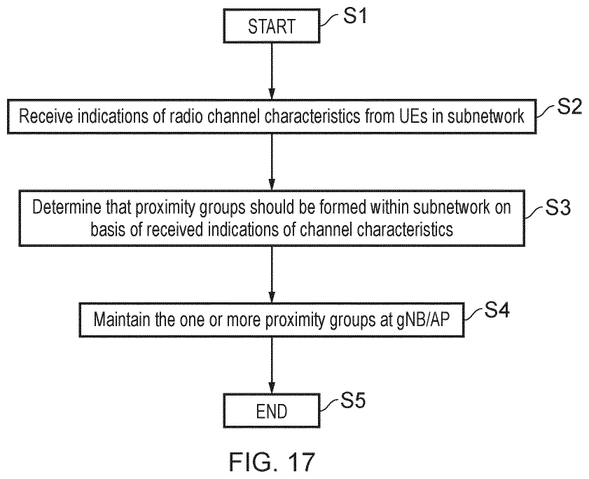

FIG. 17 shows a flow diagram illustrating an example process of communications in a communications system in accordance with embodiments of the present technique. The process shown by FIG. 17 is specifically a method of operating an infrastructure equipment (i.e. AP such as a gNB) forming part of a wireless communications network configured to transmit signals to and/or to receive signals from a communications device (i.e. UE) via a wireless access interface.

The method begins in step S1. The method comprises, in step S2, receiving, from each of a plurality of communications devices, an indication of at least one radio channel characteristic associated with that communications device, wherein the plurality of communications devices together with the infrastructure equipment form a subnetwork of the wireless communications network. In step S3, the process comprises determining, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications devices in each proximity group. Then, in step S4, the method comprises maintaining, at the infrastructure equipment, the one or more proximity groups. The process ends in step S5.

Those skilled in the art would appreciate that the method shown by FIG. 17 may be adapted in accordance with embodiments of the present technique. For example, other intermediate steps may be included in such a method, or the steps may be performed in any logical order. Though embodiments of the present technique have been described largely by way of the example communications system shown in FIG. 10, and further by way of the implementation examples shown in FIG. 11 to 16, it would be clear to those skilled in the art that they could be equally applied to other systems to those described herein, provided that these are within the scope of the claims.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure, provided that these are within the scope of the claims.

The following numbered paragraphs provide further example aspects and features of the present technique:

Paragraph 1. A method of operating an infrastructure equipment forming part of a wireless communications network configured to transmit signals to and/or to receive signals from a communications device via a wireless access interface, the method comprising
receiving, from each of a plurality of communications devices, an indication of at least one radio channel characteristic associated with that communications device, wherein the plurality of communications devices together with the infrastructure equipment form a subnetwork of the wireless communications network,
determining, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications device in each proximity group, and
maintaining, at the infrastructure equipment, the one or more proximity groups.
   Paragraph 2. A method according to Paragraph 1, comprising
transmitting, to a first of the communications devices, a first downlink grant scheduling a first set of downlink resources of the wireless access interface within which the infrastructure equipment is to transmit first downlink data to the first communications device,
receiving, from at least a second of the communications devices, a feedback signal indicating whether or not second downlink data transmitted by the infrastructure equipment to the second communications device was successfully received by the second communications device, and
transmitting, to the first communications device, a second downlink grant scheduling a second set of downlink resources based on the received feedback signal, and
wherein the first communications device and the second communications device both form part of a first of the proximity groups.
   Paragraph 3. A method according to Paragraph 2, wherein the feedback signal indicates that the second communications device did not successfully receive the second downlink data, and the method comprises
determining, on the basis of the feedback signal, that the first communications device would not successfully receive the first downlink data within the first set of downlink resources, and
transmitting, to the first communications device before receiving a feedback signal from the first communications device for the first downlink data transmitted within the first set of downlink resources, the second downlink grant scheduling the second set of downlink resources of the wireless access interface within which the infrastructure equipment is to transmit a re-transmission of the first downlink data to the first communications device,
wherein the feedback signal received from the first communications device indicates whether the initial transmission of the first downlink data within the first set of downlink resources was successfully received by the communications device
   Paragraph 4. A method according to Paragraph 2 or Paragraph 3, wherein the feedback signal indicates that the second communications device did not successfully receive the second downlink data, and the method comprises
determining, on the basis of the feedback signal, that the first communications device would not successfully receive the first downlink data within the first set of downlink resources, and
transmitting, to the first communications device before transmitting the first downlink data within the first set of downlink resources, the second downlink grant scheduling the second set of downlink resources of the wireless access interface within which the infrastructure equipment is to transmit the first downlink data to the first communications device instead of in the first set of downlink resources,
wherein the second set of downlink resources is configured with a different value of at least one parameter to the first set of downlink resources.
   Paragraph 5. A method according to any of Paragraphs 1 to 4, comprising
transmitting, to the infrastructure equipment, an indication of a maximum modulation and coding scheme, MCS, that, if the first downlink data had been transmitted in accordance with the maximum MCS, the first communications device would have been able to successfully receive the first downlink data in accordance with a predefined error rate.
   Paragraph 6. A method according to Paragraph 5, wherein the indication of the maximum MCS indicates that, if the first downlink data had been transmitted in accordance with an MCS higher than the maximum MCS, the first communications device would not have been able to successfully receive the first downlink data in accordance with the predefined error rate.
   Paragraph 7. A method according to any of Paragraphs 1 to 6, comprising
transmitting, to a first of the communications devices, a feedback signal indicating that first uplink data transmitted by the first communications device to the infrastructure equipment was not successfully received by the infrastructure equipment, and
receiving, from a second of the communications devices, a re-transmission of second uplink data, the second uplink data having previously been received by the infrastructure equipment from the second communications device, wherein the re-transmission of the second uplink data is received without the infrastructure equipment having indicated that the second communications device was to transmit the re-transmission of the second uplink data.
   Paragraph 8. A method according to any of Paragraphs 1 to 7, comprising
transmitting, to at least a first of a plurality of communications devices in a first proximity group, information to be used by the first communications device in transmitting uplink data to the infrastructure equipment.
   Paragraph 9. A method according to Paragraph 8, wherein the information comprises an indication that the infrastructure equipment did not successfully receive first uplink data transmitted by at least a second of the plurality of communications devices in the first proximity group, and wherein the method comprises
receiving, from the first communications device, a re-transmission of second uplink data, the second uplink data having previously been received by the infrastructure equipment from the first communications device, wherein the re-transmission of the second uplink data is received without the infrastructure equipment having indicated that the first communications device was to transmit the re-transmission of the second uplink data.
   Paragraph 10. A method according to Paragraph 8 or Paragraph 9, wherein the information comprises an indication of a maximum modulation and coding scheme, MCS, that, if uplink data were to be transmitted to the infrastructure equipment from that communications device in accordance with the maximum MCS, the infrastructure equipment would have been able to successfully receive the uplink data in accordance with a predefined error rate.
   Paragraph 11. A method according to Paragraph 10, wherein the indication of the maximum MCS indicates that, if the uplink data had been transmitted in accordance with an MCS higher than the maximum MCS, the infrastructure equipment would not have been able to successfully receive the uplink data in accordance with the predefined error rate.
   Paragraph 12. A method according to any of Paragraphs 1 to 11, comprising
transmitting, to a first of the communications devices, an uplink grant scheduling a set of uplink resources of the wireless access interface within which the first communications device is to transmit a re-transmission of first uplink data to the infrastructure equipment, the first uplink data having previously been received by the infrastructure equipment from the first communications device, and
receiving, from a second of the communications devices, a re-transmission of second uplink data, the second uplink data having previously been received by the infrastructure equipment from the second communications device, wherein the re-transmission of the second uplink data is received without the infrastructure equipment having indicated that the second communications device was to transmit the re-transmission of the second uplink data.
   Paragraph 13. A method according to any of Paragraphs 1 to 12, wherein the at least one radio channel characteristic indicated by each communications device is an estimation of a channel profile performed by that communications device.
   Paragraph 14. A method according to Paragraph 13, wherein the channel profile is a quantized channel profile, the quantized channel profile having been quantized by indicating a received signal strength at each of a plurality of time points relative to one or more threshold received signal strengths.
   Paragraph 15. A method according to any of Paragraphs 1 to 14, wherein the at least one radio channel characteristic indicated by each communications device is a physical position of that communications device
   Paragraph 16. A method according to any of Paragraphs 1 to 15, wherein at least one of the plurality of communications devices of the subnetwork forms part of at least two of the proximity groups.
   Paragraph 17. A method according to Paragraph 16, wherein one of the at least two proximity groups of which the at least one of the plurality of communications devices of the subnetwork forms part is associated with the infrastructure equipment, and the others of the at least two proximity groups of which the at least one of the plurality of communications devices of the subnetwork forms part is associated with one or more other infrastructure equipment of the subnetwork.
   Paragraph 18. A method according to Paragraph 16 or Paragraph 17, wherein all of the at least two proximity groups of which the at least one of the plurality of communications devices of the subnetwork forms part are associated with the infrastructure equipment.
   Paragraph 19. A method according to any of Paragraphs 16 to 18, wherein only one of the at least two proximity groups of which the at least one of the plurality of communications devices of the subnetwork forms part is active at any given time.
   Paragraph 20. A method according to any of Paragraphs 1 to 19, comprising
transmitting, to each of the plurality of communications devices of the subnetwork, a measurement command,
wherein the infrastructure equipment receives the indication of the at least one radio channel characteristic associated with each communications device based on the transmitted measurement command.
   Paragraph 21. A method according to Paragraph 20, wherein the measurement command indicates that each communications device is to transmit the indication of the at least one radio channel characteristic associated with that communications device if that communications device moves out of a predetermined geographical area.
   Paragraph 22. A method according to Paragraph 20 or Paragraph 21, wherein the measurement command indicates that each communications device is to transmit the indication of the at least one radio channel characteristic associated with that communications device if an estimation of a channel profile performed by that communications device changes from a previous estimation of the channel profile.
   Paragraph 23. A method according to any of Paragraphs 1 to 22, comprising
transmitting, to each of the plurality of communications devices of the subnetwork, an indication of a configuration in accordance with which that communications device is to transmit measurements to the infrastructure equipment,
wherein the infrastructure equipment receives the indication of the at least one radio channel characteristic associated with each communications device based on the indicated configuration.
   Paragraph 24. A method according to any of Paragraphs 1 to 23, wherein the infrastructure equipment receives the indication of the at least one radio channel characteristic associated with each communications device together with a feedback signal indicating whether or not that communications device successfully received at least one downlink signal transmitted to it by the infrastructure equipment.
   Paragraph 25. A method according to any of Paragraphs 1 to 24, comprising
transmitting, to one or more of the plurality of communications devices, an indication of the proximity group of which that communications device forms part.
   Paragraph 26. A method according to any of Paragraphs 1 to 25, comprising
transmitting, to one or more of the plurality of communications devices, an indication of identifiers associated with one or more others of the plurality of communications devices with which that communications device forms part of the same proximity group.
   Paragraph 27. A method according to any of Paragraphs 1 to 26, comprising
determining that at least one of the communications devices should be removed from a proximity group of which it currently forms part.
   Paragraph 28. A method according to any of Paragraphs 1 to 27, comprising
determining that at least one of the communications devices should be added to an existing proximity group of which it currently does not form part.
   Paragraph 29. A method according to any of Paragraphs 1 to 28, comprising
receiving, from each of the plurality of communications devices, one or more reference signals, wherein the one or more reference signals comprise the received indication of the at least one radio channel characteristic, and
determining the at least one radio channel characteristic from the received one or more reference signals.
   Paragraph 30. An infrastructure equipment forming part of a wireless communications network, the infrastructure equipment comprising
transceiver circuitry configured to transmit signals to and/or to receive signals from a communications device via a wireless access interface, and
controller circuitry configured in combination with the transceiver circuitry
to receive, from each of a plurality of communications devices, an indication of at least one radio channel characteristic associated with that communications device, wherein the plurality of communications devices together with the infrastructure equipment form a subnetwork of the wireless communications network,
to determine, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications device in each proximity group, and
to maintain, at the infrastructure equipment, the one or more proximity groups.
   Paragraph 31. Circuitry for an infrastructure equipment forming part of a wireless communications network, the infrastructure equipment comprising
transceiver circuitry configured to transmit signals to and/or to receive signals from a communications device via a wireless access interface, and
controller circuitry configured in combination with the transceiver circuitry
to receive, from each of a plurality of communications devices, an indication of at least one radio channel characteristic associated with that communications device, wherein the plurality of communications devices together with the infrastructure equipment form a subnetwork of the wireless communications network,
to determine, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications device in each proximity group, and
to maintain, at the infrastructure equipment, the one or more proximity groups.
   Paragraph 32. A method of operating a communications device configured to transmit signals to and/or to receive signals from a wireless communications network via a wireless access interface, the method comprising
transmitting, to an infrastructure equipment of the wireless communications network, an indication of at least one radio channel characteristic associated with the communications device, wherein the communications device forms a subnetwork of the wireless communications network together with the infrastructure equipment and one or more other communications devices,
wherein the communications device and at least a second of the other communications devices each form part of a first proximity group of the subnetwork, the first proximity group being associated with the infrastructure equipment.
   Paragraph 33. A method according to Paragraph 32, wherein the first proximity group is one of a plurality of proximity groups, each of the proximity groups forming part of the subnetwork, and wherein each of the proximity groups comprises two or more of the communications devices of the subnetwork.
   Paragraph 34. A method according to Paragraph 33, wherein the communications device forms part of a second of the proximity groups in addition to the first proximity group.
   Paragraph 35. A method according to Paragraph 34, wherein the first proximity group is associated with the infrastructure equipment, and the second proximity group is associated with a second infrastructure equipment of the subnetwork.
   Paragraph 36. A method according to Paragraph 34 or Paragraph 35, wherein the first proximity group and the second proximity group are both associated with the infrastructure equipment.
   Paragraph 37. A method according to any of Paragraphs 34 to 36, wherein only one of first proximity group and the second proximity group is active at any given time.
   Paragraph 38. A method according to any of Paragraphs 32 to 37, comprising
receiving, from the infrastructure equipment, a first downlink grant scheduling a first set of downlink resources of the wireless access interface within which the infrastructure equipment is to transmit first downlink data to the communications device,
wherein the first set of downlink resources are scheduled based on a feedback signal transmitted by a second communications device to the infrastructure equipment in response to second downlink data transmitted by the infrastructure equipment to the second communications device indicating whether or not the second downlink data transmitted by the infrastructure equipment to the second communications device was successfully received by the second communications device.
   Paragraph 39. A method according to Paragraph 38, wherein the first downlink grant indicates that the transmission of the first downlink data within the first set of downlink resources is to be a re-transmission of the first downlink data, and wherein the first downlink grant is received by the communications device before the communications device transmits a feedback signal in response to an initial transmission of the first downlink data from the infrastructure equipment, wherein the feedback signal indicates whether the initial transmission of the first downlink data was successfully received by the communications device.
   Paragraph 40. A method according to Paragraph 38 or Paragraph 39, wherein the first downlink grant indicates that the communications device is to receive the first downlink data from the infrastructure equipment in the first set of downlink resources instead of in a second set of downlink resources which were indicated in a previously received downlink grant,
wherein the first set of downlink resources is configured with a different value of at least one parameter to the second set of downlink resources.
   Paragraph 41. A method according to any of Paragraphs 32 to 40, comprising
transmitting, to the infrastructure equipment, an indication of a maximum modulation and coding scheme, MCS, that, if the first downlink data had been transmitted in accordance with the maximum MCS, the communications device would have been able to successfully receive the first downlink data in accordance with a predefined error rate.
   Paragraph 42. A method according to Paragraph 41, wherein the indication of the maximum MCS indicates that, if the first downlink data had been transmitted in accordance with an MCS higher than the maximum MCS, the communications device would not have been able to successfully receive the first downlink data in accordance with the predefined error rate.
   Paragraph 43. A method according to any of Paragraphs 32 to 42, comprising
receiving, from the second communications device, an indication that the infrastructure equipment did not successfully receive first uplink data transmitted by the second communications device to the infrastructure equipment, and
transmitting, to the infrastructure equipment in response to receiving the indication from the second communications device, a re-transmission of second uplink data, the second uplink data having previously been transmitted to the infrastructure equipment by the communications device, wherein the re-transmission of the second uplink data is transmitted by the communications device without the infrastructure equipment having indicated that the communications device was to transmit the re-transmission of the second uplink data.
   Paragraph 44. A method according to any of Paragraphs 32 to 43, comprising
receiving, from the infrastructure equipment, information to be used by the communications device in transmitting uplink data to the infrastructure equipment.
   Paragraph 45. A method according to Paragraph 44, wherein the information comprises an indication that the infrastructure equipment did not successfully receive first uplink data transmitted by at least the second communications device in the first proximity group, and wherein the method comprises
transmitting, to the infrastructure equipment, a re-transmission of second uplink data, the second uplink data having previously been transmitted by the communications device to the infrastructure equipment, wherein the re-transmission of the second uplink data is transmitted without the infrastructure equipment having indicated that the communications device was to transmit the re-transmission of the second uplink data.
   Paragraph 46. A method according to Paragraph 44 or Paragraph 45, wherein the information comprises an indication of a maximum modulation and coding scheme, MCS, that, if the communications device was to transmit uplink data to the infrastructure equipment in accordance with the maximum MCS, the infrastructure equipment would be able to successfully receive the uplink data in accordance with a predefined error rate.
   Paragraph 47. A method according to Paragraph 46, wherein the indication of the maximum MCS indicates that, if the uplink data had been transmitted in accordance with an MCS higher than the maximum MCS, the infrastructure equipment would not have been able to successfully receive the uplink data in accordance with the predefined error rate.
   Paragraph 48. A method according to any of Paragraphs 32 to 47, comprising
receiving, from the second communications device, an indication that the infrastructure equipment has transmitted an uplink grant to the second communications device, the uplink grant scheduling a set of uplink resources of the wireless access interface within which the second communications device is to transmit a re-transmission of first uplink data to the infrastructure equipment, the first uplink data having previously been transmitted by the second communications device to the infrastructure equipment, and
transmitting, to the infrastructure equipment in response to receiving the indication from the second communications device, a re-transmission of second uplink data, the second uplink data having previously been transmitted to the infrastructure equipment by the communications device, wherein the re-transmission of the second uplink data is transmitted by the communications device without the infrastructure equipment having indicated that the communications device was to transmit the re-transmission of the second uplink data.
   Paragraph 49. A method according to any of Paragraphs 32 to 48, wherein the at least one radio channel characteristic indicated by the communications device is an estimation of a channel profile performed by the communications device.
   Paragraph 50. A method according to Paragraph 49, wherein the channel profile is a quantized channel profile, the quantized channel profile having been quantized by the communications device by indicating a received signal strength at each of a plurality of time points relative to one or more threshold received signal strengths.
   Paragraph 51. A method according to any of Paragraphs 32 to 50, wherein the at least one radio channel characteristic indicated by the communications device is a physical position of the communications device.
   Paragraph 52. A method according to any of Paragraphs 32 to 51, comprising
receiving, from the infrastructure equipment, a first downlink grant scheduling a first set of downlink resources of the wireless access interface within which the infrastructure equipment is to transmit an initial transmission of first downlink data to the communications device,
receiving, from the infrastructure equipment, a second downlink grant scheduling a second set of downlink resources of the wireless access interface within which the infrastructure equipment is to transmit a re-transmission of the first downlink data to the communications device,
receiving the initial transmission of the first downlink data in the first set of downlink resources from the infrastructure equipment,
determining that the initial transmission of the first downlink data was successfully receive by the communications device, and subsequently,
determining that the communications device is not to receive the re-transmission of the first downlink data in the second set of downlink resources from the infrastructure equipment.
   Paragraph 53. A method according to any of Paragraphs 32 to 52, comprising
receiving, from the infrastructure equipment, a first downlink grant scheduling a first set of downlink resources of the wireless access interface within which the infrastructure equipment is to transmit an initial transmission of first downlink data to the communications device,
receiving, from the infrastructure equipment, a second downlink grant scheduling a second set of downlink resources of the wireless access interface within which the infrastructure equipment is to transmit a re-transmission of the first downlink data to the communications device,
receiving the initial transmission of the first downlink data in the first set of downlink resources from the infrastructure equipment,
determining that the initial transmission of the first downlink data was not successfully receive by the communications device, and subsequently,
determining that the communications device is to receive the re-transmission of the first downlink data in the second set of downlink resources from the infrastructure equipment and to combine the received re-transmission of the first downlink data with the initial transmission of the first downlink data.
   Paragraph 54. A method according to any of Paragraphs 32 to 53, comprising
receiving, from the infrastructure equipment, a measurement command,
wherein the communications device transmits the indication of the at least one radio channel characteristic associated with the communications device based on the transmitted measurement command.
   Paragraph 55. A method according to Paragraph 54, wherein the measurement command indicates that the communications device is to transmit the indication of the at least one radio channel characteristic associated with the communications device if the communications device moves out of a predetermined geographical area.
   Paragraph 56. A method according to Paragraph 54 or Paragraph 55, wherein the measurement command indicates that the communications device is to transmit the indication of the at least one radio channel characteristic associated with the communications device if an estimation of a channel profile performed by the communications device changes from a previous estimation of the channel profile.
   Paragraph 57. A method according to any of Paragraphs 32 to 56, comprising
receiving, from the infrastructure equipment, an indication of a configuration in accordance with which the communications device is to transmit measurements to the infrastructure equipment,
wherein the communications device transmits the indication of the at least one radio channel characteristic associated with the communications device based on the indicated configuration.
   Paragraph 58. A method according to any of Paragraphs 32 to 57, wherein the communications device transmits the indication of the at least one radio channel characteristic associated with the communications device together with a feedback signal indicating whether or not the communications device successfully received at least one downlink signal transmitted to it by the infrastructure equipment.
   Paragraph 59. A method according to any of Paragraphs 32 to 58, comprising
receiving, from the infrastructure equipment, a first indication that the communications device forms part of the first proximity group.
   Paragraph 60. A method according to Paragraph 59, comprising
receiving, from the infrastructure equipment subsequently to receiving the first indication, a second indication that the communications device no longer forms part of the first proximity group.
   Paragraph 61. A method according to any of Paragraphs 32 to 60, comprising
receiving, from the infrastructure equipment, an indication of identifiers associated with each of the communications devices with which the communications device forms part of the first proximity group.
   Paragraph 62. A method according to any of Paragraphs 32 to 61, comprising
transmitting, to the infrastructure equipment, one or more reference signals, wherein the one or more reference signals comprise the transmitted indication of the at least one radio channel characteristic.
   Paragraph 63. A communications device comprising
transceiver circuitry configured to transmit signals to and/or to receive signals from a wireless communications network via a wireless access interface, and
controller circuitry configured in combination with the transceiver circuitry
to transmit, to an infrastructure equipment of the wireless communications network, an indication of at least one radio channel characteristic associated with the communications device, wherein the communications device forms a subnetwork of the wireless communications network together with the infrastructure equipment and one or more other communications devices,
wherein the communications device and at least a second of the other communications devices each form part of a first proximity group of the subnetwork, the first proximity group being associated with the infrastructure equipment.
   Paragraph 64. Circuitry for a communications device comprising
transceiver circuitry configured to transmit signals to and/or to receive signals from a wireless communications network via a wireless access interface, and
controller circuitry configured in combination with the transceiver circuitry
to transmit, to an infrastructure equipment of the wireless communications network, an indication of at least one radio channel characteristic associated with the communications device, wherein the communications device forms a subnetwork of the wireless communications network together with the infrastructure equipment and one or more other communications devices,
wherein the communications device and at least a second of the other communications devices each form part of a first proximity group of the subnetwork, the first proximity group being associated with the infrastructure equipment.
   Paragraph 65. A wireless communications system comprising an infrastructure equipment according to Paragraph 30 and a communications device according to Paragraph 63.
   Paragraph 66. A computer program comprising instructions which, when loaded onto a computer, cause the computer to perform a method according to any of Paragraphs 1 to 29 or any of Paragraphs 32 to 62.
   Paragraph 67. A non-transitory computer-readable storage medium storing a computer program according to Paragraph 66.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors. Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.913, “Study on Scenarios and Requirements for Next Generation Access Technologies (Release 14)”, third Generation Partnership Project, v14.3.0, August 2017.
[2] RP-190726, “Physical layer enhancements for NR ultra-reliable and low latency communication (URLLC)”, Huawei, HiSilicon, RAN#83, March 2019.
[3] RP-201310, “Revised WID: Enhanced Industrial Internet of Things (IoT) and ultra-reliable and low latency communication (URLLC) support for NR,” Nokia, Nokia Shanghai Bell, RAN#88e, July 2020.
[4] European Patent Application, Publication No. EP4104343.
[5] R1-1808256, “Prediction-Based early feedback,” TCL Communication, RAN 1#93, August 2018.

1. A method of operating an infrastructure equipment forming part of a wireless communications network configured to transmit signals to and/or to receive signals from a communications device via a wireless access interface, the method comprising
receiving, from each of a plurality of communications devices, an indication of at least one radio channel characteristic associated with that communications device, wherein the plurality of communications devices together with the infrastructure equipment form a subnetwork of the wireless communications network,
determining, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications device in each proximity group, and
maintaining, at the infrastructure equipment, the one or more proximity groups.

2. A method according to claim 1, comprising
transmitting, to a first of the communications devices, a first downlink grant scheduling a first set of downlink resources of the wireless access interface within which the infrastructure equipment is to transmit first downlink data to the first communications device,
receiving, from at least a second of the communications devices, a feedback signal indicating whether or not second downlink data transmitted by the infrastructure equipment to the second communications device was successfully received by the second communications device, and
transmitting, to the first communications device, a second downlink grant scheduling a second set of downlink resources based on the received feedback signal, and
wherein the first communications device and the second communications device both form part of a first of the proximity groups.

3. A method according to claim 2, wherein the feedback signal indicates that the second communications device did not successfully receive the second downlink data, and the method comprises
determining, on the basis of the feedback signal, that the first communications device would not successfully receive the first downlink data within the first set of downlink resources, and
transmitting, to the first communications device before receiving a feedback signal from the first communications device for the first downlink data transmitted within the first set of downlink resources, the second downlink grant scheduling the second set of downlink resources of the wireless access interface within which the infrastructure equipment is to transmit a re-transmission of the first downlink data to the first communications device,
wherein the feedback signal received from the first communications device indicates whether the initial transmission of the first downlink data within the first set of downlink resources was successfully received by the communications device

4. A method according to claim 2, wherein the feedback signal indicates that the second communications device did not successfully receive the second downlink data, and the method comprises
determining, on the basis of the feedback signal, that the first communications device would not successfully receive the first downlink data within the first set of downlink resources, and
transmitting, to the first communications device before transmitting the first downlink data within the first set of downlink resources, the second downlink grant scheduling the second set of downlink resources of the wireless access interface within which the infrastructure equipment is to transmit the first downlink data to the first communications device instead of in the first set of downlink resources,
wherein the second set of downlink resources is configured with a different value of at least one parameter to the first set of downlink resources.

5. A method according to claim 1, comprising
transmitting, to the infrastructure equipment, an indication of a maximum modulation and coding scheme, MCS, that, if the first downlink data had been transmitted in accordance with the maximum MCS, the first communications device would have been able to successfully receive the first downlink data in accordance with a predefined error rate.

6. A method according to claim 5, wherein the indication of the maximum MCS indicates that, if the first downlink data had been transmitted in accordance with an MCS higher than the maximum MCS, the first communications device would not have been able to successfully receive the first downlink data in accordance with the predefined error rate.

7. A method according to claim 1, comprising
transmitting, to a first of the communications devices, a feedback signal indicating that first uplink data transmitted by the first communications device to the infrastructure equipment was not successfully received by the infrastructure equipment, and
receiving, from a second of the communications devices, a re-transmission of second uplink data, the second uplink data having previously been received by the infrastructure equipment from the second communications device, wherein the re-transmission of the second uplink data is received without the infrastructure equipment having indicated that the second communications device was to transmit the re-transmission of the second uplink data.

8. A method according to claim 1, comprising
transmitting, to at least a first of a plurality of communications devices in a first proximity group, information to be used by the first communications device in transmitting uplink data to the infrastructure equipment.

9. A method according to claim 8, wherein the information comprises an indication that the infrastructure equipment did not successfully receive first uplink data transmitted by at least a second of the plurality of communications devices in the first proximity group, and wherein the method comprises
receiving, from the first communications device, a re-transmission of second uplink data, the second uplink data having previously been received by the infrastructure equipment from the first communications device, wherein the re-transmission of the second uplink data is received without the infrastructure equipment having indicated that the first communications device was to transmit the re-transmission of the second uplink data.

10. A method according to claim 8, wherein the information comprises an indication of a maximum modulation and coding scheme, MCS, that, if uplink data were to be transmitted to the infrastructure equipment from that communications device in accordance with the maximum MCS, the infrastructure equipment would have been able to successfully receive the uplink data in accordance with a predefined error rate.

11. A method according to claim 10, wherein the indication of the maximum MCS indicates that, if the uplink data had been transmitted in accordance with an MCS higher than the maximum MCS, the infrastructure equipment would not have been able to successfully receive the uplink data in accordance with the predefined error rate.

12. A method according to claim 1, comprising
transmitting, to a first of the communications devices, an uplink grant scheduling a set of uplink resources of the wireless access interface within which the first communications device is to transmit a re-transmission of first uplink data to the infrastructure equipment, the first uplink data having previously been received by the infrastructure equipment from the first communications device, and
receiving, from a second of the communications devices, a re-transmission of second uplink data, the second uplink data having previously been received by the infrastructure equipment from the second communications device, wherein the re-transmission of the second uplink data is received without the infrastructure equipment having indicated that the second communications device was to transmit the re-transmission of the second uplink data.

13. A method according to claim 1, wherein the at least one radio channel characteristic indicated by each communications device is an estimation of a channel profile performed by that communications device.

14. A method according to claim 13, wherein the channel profile is a quantized channel profile, the quantized channel profile having been quantized by indicating a received signal strength at each of a plurality of time points relative to one or more threshold received signal strengths.

15. A method according to claim 1, wherein the at least one radio channel characteristic indicated by each communications device is a physical position of that communications device.

16. A method according to claim 1, wherein at least one of the plurality of communications devices of the subnetwork forms part of at least two of the proximity groups.

17.-19. (canceled)

20. A method according to claim 1, comprising
transmitting, to each of the plurality of communications devices of the subnetwork, a measurement command,
wherein the infrastructure equipment receives the indication of the at least one radio channel characteristic associated with each communications device based on the transmitted measurement command.

21.-22. (canceled)

23. A method according to claim 1, comprising
transmitting, to each of the plurality of communications devices of the subnetwork, an indication of a configuration in accordance with which that communications device is to transmit measurements to the infrastructure equipment,
wherein the infrastructure equipment receives the indication of the at least one radio channel characteristic associated with each communications device based on the indicated configuration.

24.-29. (canceled)

30. An infrastructure equipment forming part of a wireless communications network, the infrastructure equipment comprising
transceiver circuitry configured to transmit signals to and/or to receive signals from a communications device via a wireless access interface, and
controller circuitry configured in combination with the transceiver circuitry
to receive, from each of a plurality of communications devices, an indication of at least one radio channel characteristic associated with that communications device, wherein the plurality of communications devices together with the infrastructure equipment form a subnetwork of the wireless communications network,
to determine, based on the received indications of the at least one radio channel characteristic, that one or more proximity groups are to be formed, wherein each of the proximity groups is to comprise at least two of the plurality of communications devices of the subnetwork, the at least one radio channel characteristic being similar for all of the at least two communications device in each proximity group, and
to maintain, at the infrastructure equipment, the one or more proximity groups.

31.-62. (canceled)

63. A communications device comprising
transceiver circuitry configured to transmit signals to and/or to receive signals from a wireless communications network via a wireless access interface, and
controller circuitry configured in combination with the transceiver circuitry
to transmit, to an infrastructure equipment of the wireless communications network, an indication of at least one radio channel characteristic associated with the communications device, wherein the communications device forms a subnetwork of the wireless communications network together with the infrastructure equipment and one or more other communications devices,
wherein the communications device and at least a second of the other communications devices each form part of a first proximity group of the subnetwork, the first proximity group being associated with the infrastructure equipment.

64.-67. (canceled)
